(19) United States
(12) Patent Application Publication
(10) Pub. No.: US 2009/0085999 A1
(43) Pub. Date: Apr. 2, 2009

(54) COATER AND INK-JET RECORDING DEVICE USING THE SAME

(76) Inventor: Koji FURUKAWA, Kanagawa (JP)

Correspondence Address: BIRCH STEWART KOLASCH & BIRCH, PO BOX 747, FALLS CHURCH, VA, 22040-0747, US

(21) Appl. No.: 12/239,375

(22) Filed: Sep. 26, 2008

(30) Foreign Application Priority Data
Sep. 28, 2007 (JP) 2007-255985

(51) Int. Cl. B41J 2/01; B05C 5/00

(52) U.S. Cl. 347/102; 118/300

(57) ABSTRACT

The coater includes a liquid holding vessel holding a functional liquid, a coating roll having a surface, a part of which is immersed in the functional liquid in the liquid holding vessel, the coating roll having recesses for retaining the functional liquid, a coating roll rotating device rotating the coating roll, a liquid flow generator which flows a region of the functional liquid held in the liquid holding vessel where the functional liquid contacts the coating roll, in a direction opposite to a rotational direction of a portion of the coating roll which is immersed in the functional liquid within the liquid holding vessel, and a transport device transporting an object coated with the functional liquid upon contact with the coating roll. The coater is capable of uniformly coating a highly viscous functional liquid at a high speed.

### BACKGROUND OF THE INVENTION

The present invention belongs to a field of coaters for liquid coating, and more specifically relates to a coater for coating a functional liquid onto an object using a roller, and an ink-jet recording device using such a coater.

One method of forming images on a recording medium involves image formation by ejecting ink droplets from an ink-jet head.

Image recording devices which use the ink-jet head include, for example, the ink-jet recording devices described in JP 2003-11341 A and JP 03-222749 A.

JP 2003-11341 A describes an ink-jet recording device which employs an ink-jet recording method in which an active light-curable compound-containing ink is deposited onto a recording medium by an ink-jet system, then cured, the ink-jet recording method including forming images with inks of two or more colors, and irradiating the images with active light within 10 seconds after all of the inks required for image formation have been ejected. JP 2003-11341 A also describes that any conventionally known multi-channel ink-jet head may be used as the ink-jet head.

JP 03-222749 A describes an ink-jet recording device in which a monolayer or multilayer coating is formed on a recording medium, an image is formed by an ink-jet system on the coating which is still uncured, and heat or active energy rays are applied to cure the coating and ink simultaneously.

The device for coating a functional liquid onto an object as described in JP 2003-19453 A is a coater which includes a coating liquid reservoir containing a coating liquid (functional liquid), a coating roll having recessed cells formed thereon and partially immersed in the coating liquid within the coating liquid reservoir, and an ultrasonic oscillator applying ultrasonic waves to the coating liquid reservoir and which coats the coating liquid onto an object with a coating roll as the ultrasonic oscillator causes the coating liquid in the coating liquid reservoir to vibrate.

### SUMMARY OF THE INVENTION

In such ink-jet recording devices, when an image is recorded on a recording medium, bleeding may occur due to the surface energy of the recording medium depending on the recording medium type, or when ink droplets are continuously ejected onto a recording medium to deposit dots in a neighboring or superposed manner as in the ink-jet recording device described in JP 2003-11341 A, the ink droplets on the recording medium may coalesce due to the surface tension, causing bleeding (deposition interference) which hampers formation of desired dots, thus leading to deterioration in image quality.

These problems are solved by coating a functional liquid onto a recording medium to form a coating layer thereon as described in JP 03-222749 A, and image can be thus formed on various recording media.

However, if the coating layer formed on the recording medium is uneven, the image formed on the coating layer will not become uniform.

In order to solve this problem, a so-called gravure roll which is a coating roll having recessed cells formed thereon is used as in the coater described in JP 2003-19453 A. A functional liquid is ultrasonically vibrated to be filled into the cells of the coating roll, thus enabling the functional liquid impregnated into the coating roll to be adjusted to a fixed amount, achieving formation of a uniform coating layer on the recording medium.

However, even in the case where the coater described in JP 2003-19453 A is used, the transport speed of the recording medium is increased, which may cause nonuniformity in coating if the functional liquid is coated at a high speed or if a higher viscosity liquid is used as the functional liquid.

When an image is formed on the coating layer which is still uncured as in the ink-jet recording device described in JP 03-222749 A, the coating liquid remains uncured between dots deposited in a neighboring manner, as a result of which the image formed is not satisfactory and is low in color reproducibility.

It is therefore an object of the invention to provide a coater which solves the above-described conventional problems and which is capable of uniformly coating a highly viscous liquid at a high speed.

Another object of the invention is to provide an ink-jet recording device which solves the above-described conventional problems and which is capable of creating high-resolution and high-quality prints at a high speed.

According to the invention, by flowing a region of the functional liquid held in the reservoir where the functional liquid is in contact with the coating roll in a direction opposite to the direction in which the portion of the coating roll immersed in the functional liquid within the reservoir rotates and/or disposing a brush in a region of the reservoir where the functional liquid is held so as to be in contact with the coating roll, the coating roll can uniformly receive the functional liquid to enable a higher viscous functional liquid to be uniformly coated on an object at a high speed. This makes it possible to use various types of functional liquids and to uniformly coat them at a high speed to achieve an improved production rate while forming a uniform functional liquid layer.

Provision of a uniform undercoat at a high speed and its subsequent image formation enable images to be formed on various recording media at a high speed.

In addition, semi-curing of the undercoat and its subsequent image formation on the semi-cured undercoat enable high-definition and high-quality images to be formed to achieve production of higher-quality and higher-definition prints at a high speed.

### BRIEF DESCRIPTION OF THE DRAWINGS

In the accompanying drawings:

FIG. 1 is a front view schematically showing the structure of an embodiment of an ink-jet recording device according to the invention;

FIG. 2 is a front view schematically showing in an enlarged scale the structure of an undercoat forming section of the ink-jet recording device shown in FIG. 1;

FIG. 3 is a schematic sectional view of a recording medium where ink droplets have been deposited onto a semi-cured undercoating liquid;

FIGS. 4A and 4B are schematic sectional views of recording media where ink droplets have been deposited onto an undercoating liquid that is in an uncured state;

FIG. 4C is a schematic sectional view of a recording medium where ink droplets have been deposited onto an undercoating liquid that is in a completely cured state;

FIG. 5 is a schematic sectional view of a recording medium where ink droplets have been deposited onto a semi-cured ink liquid;

FIGS. 6A and 6B are schematic sectional views of recording media where ink droplets have been deposited onto an ink liquid that is in an uncured state;

FIG. 6C is a schematic sectional view of a recording medium where ink droplets have been deposited onto an ink liquid that is in a completely cured state;

FIGS. 7A to 7D are schematic diagrams showing steps in the formation of an image on a recording medium; and

FIG. 8 is a front view showing another example of the undercoat forming section.

### DETAILED DESCRIPTION OF THE INVENTION

The coater and ink-jet recording device according to the present invention are described more fully below based on the embodiments shown in the accompanying diagrams.

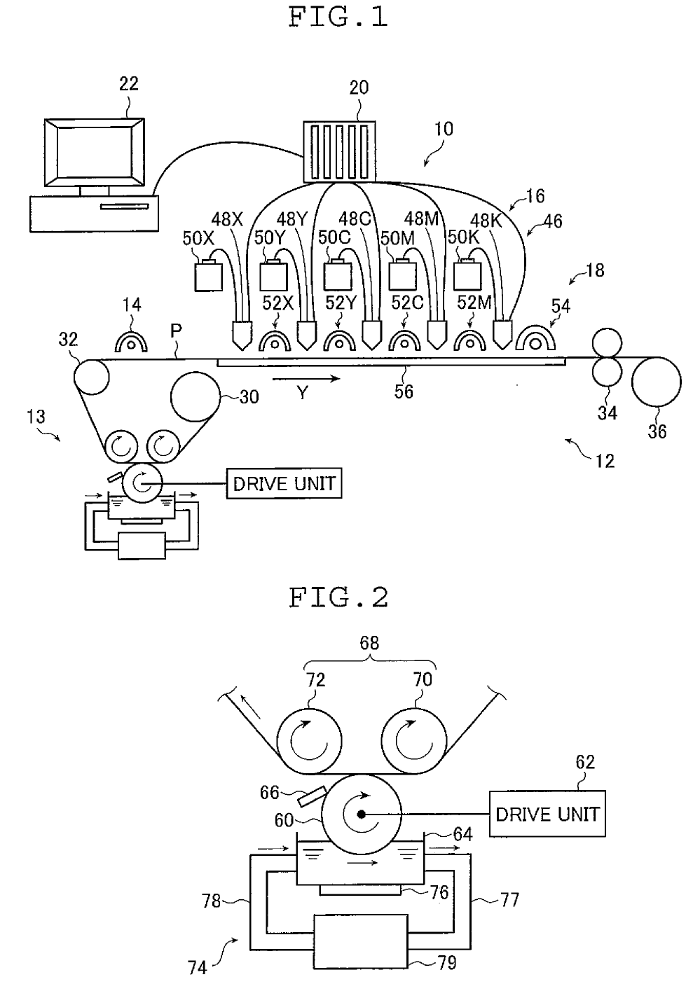

FIG. 1 is a front view schematically showing the structure of an embodiment of an ink-jet recording device 10 of the present invention in which the coater of the present invention is used in an undercoat forming section 13. FIG. 2 is a front view schematically showing in an enlarged scale the structure of the undercoat forming section 13 of the ink-jet recording device shown in FIG. 1.

The embodiments discussed below are directed to active light-curable ink-jet recording devices which use an ultraviolet light-curable ink (UV-curable ink) as the active light-curable ink (also referred to as “active energy ray-curable ink”) that cures under irradiation with active light (also referred to as “active energy rays”). However, the invention is not limited to these embodiments, and may apply to ink-jet recording devices in which various types of active light-curable inks are used.

As shown in FIG. 1, the ink-jet recording device 10 has a transport section 12 which transports a recording medium P, the undercoat forming section 13 which coats an undercoating liquid onto the recording medium P, an undercoating liquid semi-curing section 14 which semi-cures the undercoating liquid that has been coated onto the recording medium P, an image recording section 16 which records an image on the recording medium P, an image fixing section 18 which fixes the image recorded on the recording medium P, and a control unit 20 which controls the ejection of ink droplets from the image recording section 16.

An input unit 22 is connected to the control unit 20 of the ink-jet recording device 10. The input unit 22 may be an image reading unit such as a scanner or any of various types of devices which transmit image data, including image processing devices such as a personal computer. Any of various connection methods, whether wired or wireless, may be used to connect the input unit 22 and the control unit 20.

The transport section 12, which has a feed roll 30, a transport roll 32, a transport roller pair 34 and a recovery roll 36, feeds, transports and recovers the recording medium P.

The feed roll 30 has a web-type recording medium P wrapped thereon in the form of a roll, and feeds the recording medium P.

The transport roll 32 is disposed downstream of the feed roll 30 in the direction of travel of the recording medium P, and transports the recording medium P that has been let out from the feed roll 30 to the downstream side in the direction of travel.

The transport roller pair 34 is a pair of rollers which are disposed on the downstream side of the transport roll 32 in the travel path of the recording medium P and which grip therebetween the recording medium P that has passed around the transport roll 32 and transport it to the downstream side in the direction of travel.

The recovery roll 36 is disposed the furthest downstream in the travel path of the recording medium P. The recovery roll 36 takes up the recording medium P which has been fed from the feed roll 30, has been transported by the transport roll 32 and the transport roller pair 34, and has passed through positions facing the subsequently described undercoat forming section 13, undercoating liquid semi-curing section 14, image recording section 16 and image fixing section 18.

Here, the transport roll 32, the transport roller pair 34 and the recovery roll 36 are connected to drive units (not shown) and rotated by the drive units.

Next, the positional relationship of the respective components in the transport section 12 and the travel path of the recording medium P are described.

The feed roll 30 is disposed below the transport roll 32, the transport roller pair 34 and the recovery roll 36 in a vertical direction, and on the side of the recovery roll 36 from the transport roll 32 in a horizontal direction. Moreover, the transport roll 32, the transport roller pair 34 and the recovery roll 36 are disposed linearly in a direction parallel to the horizontal direction. A positioning unit 68 of the undercoat forming section 13 to be described later which comes in contact with the recording medium P is disposed between the feed roll 30 and the transport roll 32 below the feed roll 30 in the vertical direction.

The transport section 12 has the layout as described above. The recording medium P is let out from the feed roll 30 and transported in a direction in which it is moved away from the recovery roll 36 and in an obliquely downward direction. The recording medium P having been let out from the feed roll 30 travels with the surface on which images are to be recorded facing downward.

Thereafter, the recording medium P horizontally passes the positioning unit 68, then travels toward the transport roll 32 in a direction in which it moves away from the recovery roll 36 and in an obliquely upward direction. Then, the recording medium P changes the direction of travel at the transport roll 32, passes the transport roll 32 and horizontally travels toward the recovery roll 36 where it is taken up.

The undercoat forming section 13 is situated between the feed roll 30 and the transport roll 32; that is, on the downstream side of the feed roll 30 and on the upstream side of the transport roll 32 in the direction of travel of the recording medium P.

As shown in FIG. 2, the undercoat forming section 13 has a coating roll 60 for coating an undercoating liquid onto the recording medium P, a drive unit 62 which drives the coating roll 60, a reservoir (liquid holding vessel) 64 which supplies the undercoating liquid to the coating roll 60, a blade 66 which adjusts the amount of undercoating liquid picked up by the coating roll 60, the positioning unit 68 which supports the recording medium P so that the recording medium P assumes a predetermined position relative to the coating roll 60, a circulating unit 74 which circulates the undercoating liquid in the reservoir 64, and an ultrasonic generator 76 which applies ultrasonic waves to the undercoating liquid held in the reservoir 64.

The coating roll 60 is disposed between the feed roll 30 and the transport roll 32 in the travel path of the recording medium P so as to be in contact with the surface of the recording medium P on which images are to be formed. That is, the coating roll 60 is in contact with the downwardly facing surface of the recording medium P being transported from the feed roll 30 to the transport roll 32.

The coating roll 60, which is a roll that is longer than the width of the recording medium P, is a so-called gravure roll on the surface (peripheral face) of which recessed features are formed at fixed, i.e., uniform, intervals. Here, the shapes of the recessed features formed on the coating roll 60 are not subject to any particular limitation. Any of various shapes may be used, including round, rectangular, polygonal or star-like shapes. Alternatively, the recessed features may be formed as grooves extending over the entire circumference of the coating roll.

The drive unit 62 is a drive mechanism including a motor, and gears which transmit rotation of the motor to the coating roll 60 and rotates the coating roll 60. However, the drive unit 62 is not limited to this embodiment. Any of various other drive mechanisms may instead be used to rotate the coating roll 60, including pulley driving, belt driving and direct driving.

As indicated by arrows in FIGS. 1 and 2, the drive unit 62 causes the coating roll 60 to rotate in the direction opposite to the direction of travel of the recording medium P at the portion of contact therebetween (i.e., in the clockwise direction in FIGS. 1 and 2).

The reservoir 64 has a dish-like shape open at the top, and holds in the interior thereof the undercoating liquid. The reservoir 64 is disposed underneath and adjacent to the coating roll 60, such that a portion of the coating roll 60 is immersed in the undercoating liquid held within the reservoir 64. When necessary, the undercoating liquid is fed to the reservoir 64 from a feed tank (not shown).

The blade 66 is disposed so as to be in contact with the surface of the coating roll 60. More specifically, the blade 66 is disposed, in the direction of rotation of the coating roll 60, on the downstream side of the reservoir 64 and on the upstream side of the recording medium P, and comes into contact with a portion of the coating roll 60 that has been immersed in the reservoir 64, before that portion comes into contact with the recording medium P.

The blade 66 scrapes off that portion of the undercoating liquid picked up by the coating roll 60 when immersed in the reservoir 64 which is not needed, thereby setting the quantity of undercoating liquid adhering to the coating roll 60 to a fixed amount. In this embodiment, except for the undercoating liquid retained in the recessed features formed on the surface of the coating roll 60, the blade 66 scrapes off undercoating liquid adhering to other portions of the coating roll 60 so that the portion of the coating roll 60 which comes in contact with the recording medium P has the undercoating liquid substantially only held in the recessed features.

The blade 66 scrapes off undercoating liquid excessively adhering to the surface of the coating roll 60 (i.e., surplus undercoating liquid) to make the amount of undercoating liquid adhering to the surface of the coating roll 60 constant, thus enabling the coating layer to be more uniformly formed on the recording medium.

The positioning unit 68 has a first positioning roll 70 and a second positioning roll 72, and supports the recording medium P in such a way as to ensure that the recording medium P comes into contact with the coating roll 60 at a specific position.

The first and second positioning rolls 70 and 72 are each situated on the opposite side of the recording medium P from the coating roll 60 and, in the direction of travel of the recording medium P, on either side of the coating roll 60; that is, one is situated on the upstream side, and the other is situated on the downstream side, of the coating roll 60. These first and second positioning rolls 70 and 72 support the recording medium P from the side of the recording medium P opposite to the side on which images are to be formed (i.e., the side to be coated with undercoating liquid).

The first and second positioning rolls 70 and 72 protrude outside the straight line connecting the feed roll 30 and the transport roll 32 (the side on which the travel path of the recording medium P is extended) and apply a specified degree of tension to the recording medium P being transported to prevent shifts in position of the recording medium P from occurring.

The circulating unit 74 includes a first pipe line 77 connected to one lateral surface of the reservoir 64 which is parallel to the axis of rotation of the coating roll 60, a second pipe line 78 connected to the other lateral surface of the reservoir 64 which is also parallel thereto, and a pump 79 connected to the first and second pipe lines 77 and 78, and circulates the undercoating liquid held in the reservoir 64.

The pump 79 sucks the undercoating liquid from the first pipe line 77, then discharges it to the second pipe line 78. In this way, the undercoating liquid is circulated between the circulating unit 74 and the reservoir 64 in the order of the reservoir 64, first pipe line 77, pump 79, second pipe line 78, and reservoir 64 (in the direction indicated by arrows in the lower part of FIG. 2).

The circulating unit 74 circulates the undercoating liquid (flows the undercoating liquid) at a predetermined speed in the direction opposite to the direction in which a portion of the coating roller 60 that is immersed in the undercoating liquid within the reservoir 64 rotates, that is, to the direction in which the coating roller 60 moves.

The ultrasonic generator 76 is a mechanism which generates ultrasonic vibrations such as an ultrasonic oscillator that may be used in an ultrasonic cleaner and is provided beneath the lower surface of the reservoir 64. The ultrasonic generator 76 applies ultrasonic waves to the undercoating liquid in the reservoir 64 to vibrate it.

The ultrasonic frequency from the ultrasonic generator 76 is preferably from 20 kHz to 50 kHz.

In the foregoing arrangement of the undercoat forming section 13, the drive unit 62 causes the coating roll 60 to rotate in the direction opposite to the direction of travel of the recording medium P at the portion of contact therebetween. After being immersed in the undercoating liquid which has accumulated in the reservoir 64, the surface of the rotating coating roll 60 comes into contact with the blade 66, thereby setting the amount of undercoating liquid retained on the surface to a fixed amount, then comes into contact with the recording medium P, thereby coating the undercoating liquid onto the recording medium P. By thus rotating the coating roll 60 in the direction opposite to the direction of travel of the recording medium P at the portion of contact therebetween and coating the undercoating liquid onto the recording medium P, a layer of undercoating liquid (referred to below as the “undercoat”) that has been smoothened and has a good and even coating surface state can be formed on the recording medium P. The coating roll 60 that came into contact with the recording medium P further rotates to be immersed in the reservoir 64 again.

The circulating unit 74 flows the undercoating liquid in the reservoir 64 at a predetermined speed in the direction opposite to the direction in which the portion of the coating roll immersed in the undercoating liquid within the reservoir 64 is moved, and the undercoating liquid vibrates through application of the ultrasonic waves from the ultrasonic generator 76.

Next, the undercoating liquid semi-curing section 14 is described.

The undercoating liquid semi-curing section 14 has a UV lamp and is disposed so as to face the travel path of the recording medium P. Here, the UV lamp is a light source which emits UV light and irradiates UV light onto the recording medium P. Examples of UV light sources that may be used include metal halide lamps and high-pressure mercury vapor lamps.

The undercoating liquid semi-curing section 14 exposes to UV light the entire width of the recording medium P which has been coated on the surface with the undercoating liquid and passes through a position opposed thereto, thereby rendering the undercoating liquid coated onto the surface of the recording medium P into a semi-cured state. Semi-curing of the undercoating liquid will be described later in further detail.

Next, the image recording section 16 in which ink droplets are ejected onto the recording medium to record an image and the image fixing section 18 in which the image formed on the recording medium in the image recording section 16 is cured to fix it on the recording medium are described.

The image recording section 16 has a recording head unit 46 and ink tanks 50X, 50Y, 50C, 50M and 50K.

The recording head unit 46 has recording heads 48X, 48Y, 48C, 48M and 48K.

The recording heads 48X, 48Y, 48C, 48M and 48K are arranged in this order from the upstream side to the downstream side in the direction of travel of the recording medium P. Moreover, in the recording heads 48X, 48Y, 48C, 48M and 48K, the tips of the respective ink ejection portions are disposed so as to face the path of travel of the recording medium P; that is, so as to face the recording medium P which is transported over the travel path by the transport section 12 (also referred to below as simply “facing the recording medium P”).

The recording heads 48X, 48Y, 48C, 48M and 48K are full-line, piezoelectric ink-jet heads in which a plurality of orifices (nozzles, ink ejection portions) are arranged at fixed intervals throughout in a direction perpendicular to the direction of travel of the recording medium P, that is, over the entire width of the recording medium P. These recording heads are connected to the subsequently described control unit 20 and the ink tanks 50X, 50Y, 50C, 50M and 50K. The amount of ink droplets ejected by the recording heads 48X, 48Y, 48C, 48M and 48K and the ejection timing of the droplets are controlled by the control unit 20. The recording heads 48X, 48Y, 48C, 48M and 48K ejects inks of special color (X), yellow (Y), cyan (C), magenta (M) and black (K).

A color image can be formed on the recording medium P by ejecting inks of various colors—special color (X), yellow (Y), cyan (C), magenta (M) and black (K)—from the respective recording heads 48X, 48Y, 48C, 48M and 48K toward the recording medium P while at the same time having the transport section 12 transport the recording medium P.

In the present embodiment, the recording heads are piezoelectric (piezo) elements. However, the invention is not limited in this regard. Any of various types of systems may be used in place of a piezo system, such as a thermal jet system which uses a heating element such as a heater to heat the ink and generate bubbles. In this latter system, the pressure of the bubbles propels the droplets of ink.

Any of various inks, such as white, orange, violet or green ink may be used as the special colored ink discharged from the recording head 48X.

The inks ejected from the recording heads in the present embodiment are UV-curable inks.

The ink tanks 50X, 50Y, 50C, 50M and 50K are provided for the recording heads 48X, 48Y, 48C, 48M and 48K. The respective ink tanks 50X, 50Y, 50C, 50M and 50K store inks of various colors for the recording heads, and supplies the stored inks to the corresponding recording heads 48X, 48Y, 48C, 48M and 48K.

In addition, a tabular platen 56 is disposed at a position facing the recording heads 48X, 48Y, 48C, 48M and 48K on the side of the recording medium P where images will not be formed.

The platen 56 supports the recording medium P which is transported through positions facing the respective recording heads from the side of the recording medium P on which images will not be formed; that is, from the opposite side of the recording medium P to that on which the recording head unit 46 is disposed. In this way, the distance between the recording medium P and the respective recording heads can be made constant, enabling high-resolution images to be formed on the recording medium P.

The shape of the platen 56 is not limited to a flat plate, and may have a raised, curved surface shape on the recording head side. In such a case, the recording heads 48X, 48Y, 48C, 48M and 48K are disposed at fixed distances from the platen.

Then, the image fixing section 18, which has UV irradiation units 52X, 52Y, 52C and 52M, and a final UV irradiation unit for curing 54, irradiates UV light onto the image formed on the recording medium P by the recording head unit 46, thereby semi-curing or curing the image (that is, the ink), and thus fixing the image.

The UV irradiation units 52X, 52Y, 52C and 52M are disposed on the downstream sides of the respective recording heads 48X, 48Y, 48C and 48M along the travel path of the recording medium P. In addition, the final UV irradiation unit for curing 54 is disposed on the downstream side of the recording head 48K along the travel path of the recording medium P. That is, the final UV irradiation unit for curing 54 is positioned on the downstream side of the recording head situated the furthest downstream of all the recording heads along the travel path of the recording medium P.

In other words, as shown in FIG. 1, the respective recording heads 48X, 48Y, 48C, 48M and 48K, the respective UV irradiation units 52X, 52Y, 52C and 52M, and the final UV irradiation unit for curing 54 are disposed in the following order, from the upstream to the downstream side of the travel path: recording head 48X, UV irradiation unit 52X, recording head 48Y, UV irradiation unit 52Y, recording head 48C, UV irradiation unit 52C, recording head 48M, UV irradiation unit 52M, recording head 48K, final UV irradiation unit for curing 54.

Here, the UV irradiation units 52X, 52Y, 52C and 52M and the final UV irradiation unit for curing 54 differ only in the size of the units and the target to be irradiated with UV light. Specifically, the UV irradiation units 52X, 52Y, 52C and 52M cure the images formed by the respective recording heads, whereas the final UV irradiation unit for curing 54 differs only in that it irradiates higher intensity light than the other UV irradiation units so as to reliably cure both the undercoating liquid coated onto the recording medium P and images of all the respective inks. Because the final UV irradiation unit for curing 54 has the same basic construction as the UV irradiation units 52X, 52Y, 52C and 52M, the description given below for the UV irradiation unit 52X applies collectively to all of the above UV irradiation units, including the final UV irradiation unit for curing 54.

The UV irradiation units 52X, 52Y, 52C and 52M have UV lamps and are disposed in the width direction of the recording medium P along the transport path of the recording medium P.

The UV lamps are ultraviolet light-emitting light sources which face the recording medium P side and irradiate the recording medium P with UV light. Examples of UV lamps which may be used for this purpose include various UV light sources, such as metal halide lamps and high-pressure mercury vapor lamps.

The UV irradiation units 52X, 52Y, 52C and 52M irradiates UV light onto the whole area in the width direction of the recording medium P that passes the positions opposed thereto to semi-cure the inks deposited onto the recording medium P.

The final UV irradiation unit for curing 54 irradiates UV light onto the whole area in the width direction of the recording medium P that passes the position opposed thereto to cure the inks deposited onto the recording medium P and the undercoat.

Next, the control unit 20 is connected to the respective recording heads 48X, 48Y, 48C, 48M and 48K of the recording head unit 46 and, using image data sent from the input unit 22 as the image recording signals, controls ink ejection/non-ejection from the respective recording heads 48X, 48Y, 48C, 48M and 48K so as to form images on the recording medium P.

The ink-jet recording device 10 has the basic layout as described above.

Semi-curing the undercoating liquid and ink is now described.

In the practice of the invention, the term “semi-curing the undercoating liquid” as used herein signifies partial curing, and refers to the undercoating liquid in a partially cured, i.e., an incompletely cured, state. When the undercoating liquid that has been applied onto the recording medium (base material) P is semi-cured, the degree of curing may be non-uniform; preferably, the degree of curing proceeds in the depth direction of the undercoating liquid. In the present embodiment, the undercoating liquid which is semi-cured is an undercoating liquid which forms an undercoat.

For example, when a radical-polymerizable undercoating liquid is cured in air or air that is partially substituted with an inert gas, due to the radial polymerization-suppressing effect of oxygen, radical polymerization tends to be inhibited at the surface of the undercoating liquid. As a result, semi-curing is non-uniform, there being a tendency for curing to proceed at the interior of the undercoating liquid and to be delayed at the surface.

In the practice of the invention, by using a radical-photopolymerizable undercoating liquid in the presence of oxygen which tends to inhibit radical polymerization, the undercoating liquid partially photocures, enabling the degree of cure of the undercoating liquid to be higher at the interior than at the exterior.

Alternatively, in cases where a cationic-polymerizable undercoating liquid is cured in air containing humidity, because moisture has a cationic polymerization-inhibiting effect, there is a tendency for curing to proceed at the interior of the undercoating liquid and to be delayed at the surface.

It is likewise possible for the degree of cure in the undercoating liquid to be made higher at the interior than at the exterior by using this cationic-polymerizable undercoating liquid under humid conditions that have a cationic polymerization-inhibiting effect so as to induce partial photocuring.

By thus semi-curing the undercoating liquid and depositing ink droplets on the semi-cured undercoating liquid, technical effects that are advantageous for the quality of the resulting print can be achieved. The mechanism of action can be confirmed by examining a cross-section of the print.

The semi-curing of the undercoating liquid (i.e., the undercoat formed of undercoating liquid on the recording medium) is described in detail below. As one illustration, high-density areas obtained by depositing about 12 pL of liquid ink (that is, droplets of ink) on the undercoating liquid in a semi-cured state having a thickness of about 5 μm that has been provided on a recording medium P are described below.

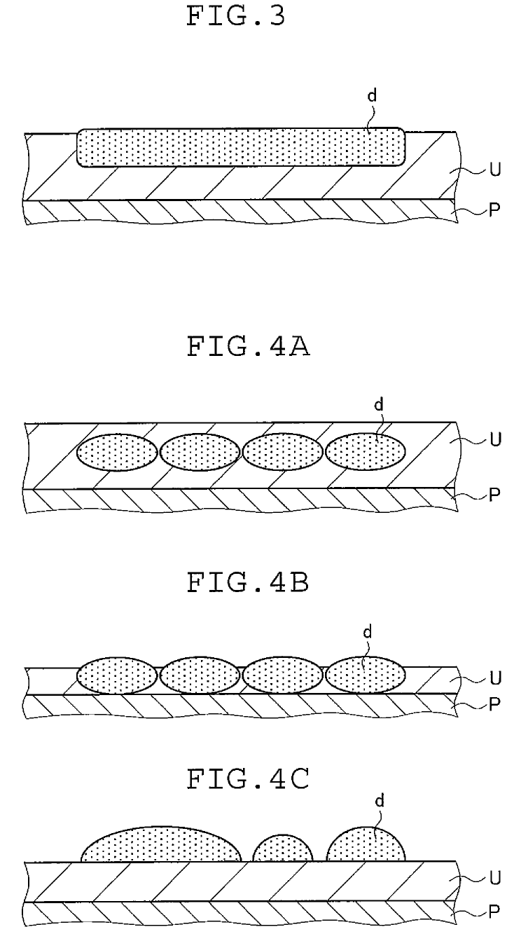

FIG. 3 is a schematic sectional view of a recording medium where ink droplets have been deposited onto a semi-cured undercoating liquid. FIGS. 4A and 4B are schematic sectional views of recording media where ink droplets have been deposited onto an undercoating liquid that is in an uncured state, and FIG. 4C is a schematic sectional view of a recording medium where ink droplets have been deposited onto an undercoating liquid that is in a completely cured state.

When the undercoating liquid is semi-cured according to the invention, the degree of cure on the recording medium P side is higher than the degree of cure at the surface layer. In this case, three features are observable. That is, as shown in FIG. 3, when ink d is deposited as droplets on a semi-cured undercoating liquid U, (1) a portion of the ink d emerges at the surface of the undercoating liquid U, (2) a portion of the ink d lies within the undercoating liquid U, and (3) the undercoating liquid is present between the bottom side of the ink d and the recording medium P.

When the ink d is deposited on the undercoating liquid U, if the undercoating liquid U and the ink d satisfy the above states (1), (2) and (3), the undercoating liquid U can be regarded as being in a semi-cured state.

By semi-curing the undercoating liquid U, that is, by curing the undercoating liquid U so that it satisfies above (1), (2) and (3), the droplets of ink d (i.e., the ink droplets) which have been deposited to a high density mutually connect, forming a film of the ink d (i.e., an ink film or ink layer), and thus providing a uniform and high color density.

By contrast, when the ink is deposited on the undercoating liquid which is in an uncured state, either or both of the following occur: all of the ink d lies within the undercoating liquid U as shown in FIG. 4A; a state arises where, as shown in FIG. 4B, the undercoating liquid U is not present below the ink d.

In this case, even when the ink is applied to a high density, the liquid droplets are mutually independent, causing the color density to decrease.

When the ink is deposited on an undercoating liquid that is completely cured, as shown in FIG. 4C, a state will arise where the ink d does not lie within the undercoating liquid U.

In this case, interference in the deposition of the droplets arises, as a result of which a uniform ink film cannot be formed and a high color reproducibility cannot be achieved (i.e., this leads to a decrease in color reproducibility).

Here, when the droplets of ink are applied to a high density, the droplets are not independent of each other. To form a uniform ink film, and also to suppress the occurrence of deposition interference, the quantity of regions where the undercoating liquid (i.e., the undercoat) is uncured per unit surface area is preferably smaller, and more preferably substantially smaller, than the maximum quantity of droplets of ink applied per unit surface area. That is, the relationship between the weight Mᵤ (also referred to as M_{undercoating liquid}) of uncured regions of the undercoat per unit surface area and the maximum weight mᵢ (also referred to as mᵢₙₖ) of the ink ejected per unit surface area preferably satisfies the condition (mᵢ/30)<Mᵤ<mᵢ, more preferably satisfies the condition (mᵢ/20)<Mᵤ<(mᵢ/3), and most preferably satisfies the condition (mᵢ/10)<Mᵤ<(mᵢ/5). As used herein, the “maximum weight of the ink ejected per unit surface area” refers to the maximum weight per color.

By letting (mᵢ/30)<Mᵤ, deposition interference can be prevented from occurring. Moreover, a high dot size reproducibility can be achieved. By letting Mᵤ<mᵢ, the ink film can be uniformly formed and a decrease in density can be prevented.

Here, the weight of uncured regions of the undercoating liquid per unit surface area is determined by a transfer test. Specifically, after completion of the semi-curing step (e.g., after exposure to active energy rays) and before deposition of the ink droplets, a permeable medium such as plain paper is pressed against the undercoating liquid which is in a semi-cured state, and the amount of the undercoating liquid that transfers to the permeable medium is determined by weight measurement. The measured value is defined as the weight of the uncured regions of the undercoating liquid.

For example, if the maximum amount of ink ejected is set to 12 picoliters per pixel at a deposition density of 600×600 dpi, the maximum weight mᵢ of the ink ejected per unit surface area becomes 0.04 g/cm² (assuming the density of the ink is about 1.1 g/cm³). Therefore, in this case, the weight Mᵤ per unit surface area of uncured regions of the undercoating liquid is preferably greater than 0.0013 g/cm² but less than 0.04 g/cm², more preferably greater than 0.002 g/cm² but less than 0.013 g/cm², and most preferably greater than 0.004 g/cm² but less than 0.008 g/cm².

In the practice of the invention, as in the case of the undercoating liquid, “semi-curing the ink” signifies partial curing, and refers to a state where the liquid ink (i.e., ink, colored liquid) is in a partially cured, but not a completely cured, state. When the ink liquid ejected onto the undercoating liquid is semi-cured, the degree of cure may be non-uniform; preferably, the degree of cure proceeds in the depth direction of the ink liquid. In the present embodiment, the ink that is to be semi-cured is in the form of ink droplets which land on the undercoat or recording medium and form an ink layer.

When this ink is semi-cured and an ink of a different hue is deposited on top of the semi-cured ink, there can be achieved a technical effect which is advantageous to the quality of the resulting print. The mechanism of action may be confirmed by examining a cross-section of the print.

Semi-curing of the ink (i.e., the ink droplets which have landed on the recording medium or the undercoat, or the ink layer formed from ink droplets which have landed) is explained below.

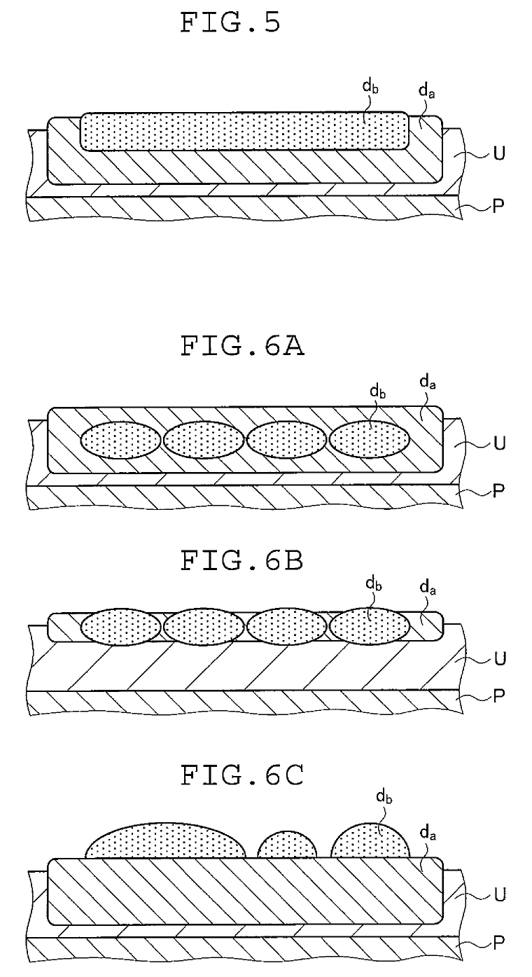

FIG. 5 is a schematic sectional view of a recording medium where a second ink d_{b} has been deposited onto a semi-cured first ink dₐ. FIGS. 6A and 6B are schematic sectional views of recording media where droplets of the second ink d_{b} have been deposited onto the first ink dₐ that is in an uncured state, and FIG. 6C is a schematic sectional view of a recording medium where droplets of the second ink d_{b} have been deposited onto the first ink dₐ that is in a completely cured state.

When a secondary color is formed by depositing droplets of the second ink d_{b} onto the first ink dₐ that has been earlier deposited as droplets, it is preferable to apply the second ink d_{b} onto the first ink dₐ with the latter in a semi-cured state.

Here, the “semi-cured state” of the first ink dₐ is similar to the above-described semi-cured state of the undercoating liquid. As shown in FIG. 5, this is a state where, when the second ink d_{b} is deposited as droplets onto the first ink dₐ, (1) a portion of the second ink d_{b} emerges at the surface of the first ink dₐ, (2) a portion of the second ink d_{b} lies within the first ink dₐ, and (3) the first ink dₐ is present below the second ink d_{b}.

By semi-curing the ink in this way, a cured film (colored film A) of the first ink dₐ and a cured film (colored film B) of the second ink d_{b} can be suitably superimposed, enabling good color reproduction to be achieved.

By contrast, when the second ink d_{b} is deposited as droplets on the first ink dₐ with the latter in an uncured state, either or both of the following occur: all of the second ink d_{b} lies within the first ink dₐ as shown in FIG. 6A; a state arises where, as shown in FIG. 6B, the first ink dₐ is not present below the second ink d_{b}. In this case, even when the second ink d_{b} is applied to a high density, the droplets are independent of each other, causing the color saturation of the secondary color to decrease.

When the second ink d_{b} is deposited as droplets on the first ink dₐ which is completely cured, as shown in FIG. 6C, a state will arise where the second ink d_{b} does not lie within the first ink dₐ. This causes interference in the deposition of the droplets to arise, as a result of which a uniform ink film cannot be formed, leading to a decline in color reproducibility.

Here, when the droplets of the second ink d_{b} are applied to a high density, the droplets are not independent of each other. To form a uniform film of the second ink d_{b}, and also to suppress the occurrence of deposition interference, the quantity of regions where the first ink dₐ is uncured per unit surface area is preferably smaller, and more preferably substantially smaller, than the maximum quantity of droplets of the second ink d_{b} applied thereon per unit surface area. That is, the relationship between the weight M_{da} (also referred to as M_{ink A}) of uncured regions of the first ink dₐ layer per unit surface area and the maximum weight m_{db} (also referred to as m_{ink B}) of the second ink d_{b} ejected thereon per unit surface area preferably satisfies the condition (m_{db}/30)<M_{da}<m_{db}, more preferably satisfies the condition (m_{db}/20)<M_{da}<(m_{db}/3), and most preferably satisfies the condition (m_{db}/10)<M_{da}<(m_{db}/5)

By letting (m_{db}/30)<M_{da}, deposition interference can be prevented from occurring. Moreover, a high dot size reproducibility can be achieved. By letting M_{da}<m_{db}, a film of the first ink dₐ can be uniformly formed and a decrease in density can be prevented.

Here, as in the case of the undercoating liquid described above, the weight of the uncured regions of the first ink dₐ per unit surface area is determined by a transfer test. Specifically, after completion of the semi-curing step (e.g., after exposure to active energy rays) and before deposition of the droplets of the second ink d_{b}, a permeable medium such as plain paper is pressed against the layer of the first ink dₐ which is in a semi-cured state, and the quantity of the first ink dₐ that transfers to the permeable medium is determined by weight measurement. The measured value is defined as the weight of the uncured regions of the ink liquid.

For example, if the maximum amount of the second ink d_{b} ejected is set to 12 picoliters per pixel at a deposition density of 600×600 dpi, the maximum weight m_{db} of the second ink d_{b} ejected per unit surface area becomes 0.04 g/cm² (assuming the density of the second ink d_{b} to be about 1.1 g/cm³). Therefore, in this case, the weight M_{da} per unit surface area of uncured regions of the first ink dₐ layer is preferably greater than 0.0013 g/cm² but less than 0.04 g/cm², more preferably greater than 0.002 g/cm² but less than 0.013 g/cm², and most preferably greater than 0.004 g/cm² but less than 0.008 g/cm².

When the semi-cured state of the undercoating liquid and/or the ink is realized by a polymerization reaction of a polymerizable compound that is initiated by the irradiation of active energy rays or heating, to enhance the scuff resistance of the print, the unpolymerization ratio (i.e., A_{after polymerization}/A_{before polymerization}) is preferably at least 0.2 but not more than 0.9, more preferably at least 0.3 but not more than 0.9, and most preferably at least 0.5 but not more than 0.9.

Here, A_{before polymerization} is the infrared absorption peak absorbance attributable to polymerizable groups before the polymerization reaction, and A_{after polymerization} is the infrared absorption peak absorbance attributable to polymerizable groups after the polymerization reaction.

For example, when the polymerizable compound included in the undercoating liquid and/or the ink is an acrylate monomer or a methacrylate monomer, absorption peaks based on polymerizable groups (acrylate groups, methacrylate groups) can be observed near 810 cm⁻¹. Accordingly, the above unpolymerization ratio is preferably defined in terms of the absorbances of these peaks. When the polymerizable compound is an oxetane compound, an absorption peak based on polymerizable groups (oxetane rings) can be observed near 986 cm⁻¹. The above unpolymerization ratio is thus preferably defined in terms of the absorbance of this peak. When the polymerizable compound is an epoxy compound, an absorption peak based on the polymerizable groups (epoxy groups) can be observed near 750 cm⁻¹. Hence, the above unpolymerization ratio is preferably defined in terms of the absorbance of this peak.

A commercial infrared spectrophotometer may be used as the means for measuring the infrared absorption spectrum. The spectrophotometer may be either a transmission-type or reflection-type system. Suitable selection according to the form of the sample is preferred. Measurement may be carried out using, for example, an FTS-6000 infrared spectrophotometer manufactured by Bio-Rad.

In the case of a curing reaction based on an ethylenically unsaturated compound or a cyclic ether, the unpolymerization ratio may be quantitatively measured from the percent conversion of ethylenically unsaturated groups or cyclic ether groups.

The method used to semi-cure the undercoating liquid and/or the ink is exemplified by known thickening methods, e.g., (1) methods that use an agglomerating effect, such as by furnishing a basic compound to an acidic polymer or by furnishing an acidic compound and a metal compound to a basic polymer; (2) methods wherein the undercoating liquid and/or the ink is prepared beforehand at a high viscosity, then the viscosity is lowered by adding thereto a low-boiling organic solvent, after which the low-boiling organic solvent is evaporated so as to return the liquid to its original high viscosity; (3) methods in which the undercoating liquid and/or the ink prepared at a high viscosity is first heated, then is cooled so as to return the liquid to its original high viscosity; and (4) methods in which the undercoating liquid and/or the ink is semi-cured through a curing reaction induced by exposing the undercoating liquid and/or the ink to active energy rays or heat. Of these, (4) methods in which the undercoating liquid and/or the ink is semi-cured through a curing reaction induced by exposing the undercoating liquid and/or the ink to active energy rays or heat are preferred.

“Methods in which the undercoating liquid and/or the ink is semi-cured through a curing reaction induced by exposing the undercoating liquid and/or the ink to active energy rays or heat” refers herein to methods in which the polymerization reaction on polymerizable compounds at the surface of the undercoating liquid and/or the ink furnished to the recording medium is carried out incompletely. At the surface of the undercoating liquid and/or the ink, compared with the interior thereof, the polymerization reaction tends to be inhibited by the influence of oxygen present in air. Therefore, by controlling the conditions of exposure to active energy rays or heat, it is possible to trigger the reaction for semi-curing the undercoating liquid and/or the ink.

The amount of energy required to semi-cure the undercoating liquid and/or the ink varies with the type and content of polymerization initiator. When the energy is applied by active energy rays, an amount of about 1 to about 500 mJ/cm² is generally preferred. When the energy is applied as heat, from 0.1 to 1 second of heating under temperature conditions where the surface temperature of the recording medium falls within a temperature range of 40 to 80° C. is preferred.

The application of active energy rays or heat, such as with active rays or heating, promotes the generation of active species by decomposition of the polymerization initiator. At the same time, the increase in active species or the rise in temperature promotes the curing reaction through polymerization or crosslinking of polymerizable or crosslinkable materials induced by the active species.

A thickening (rise in thickness) may also be suitably carried out by exposure to active rays or by heating.

The ink-jet recording device of the invention is described below in further detail by referring to the operation of the ink-jet recording device 10, that is, its recording action on the recording medium P.

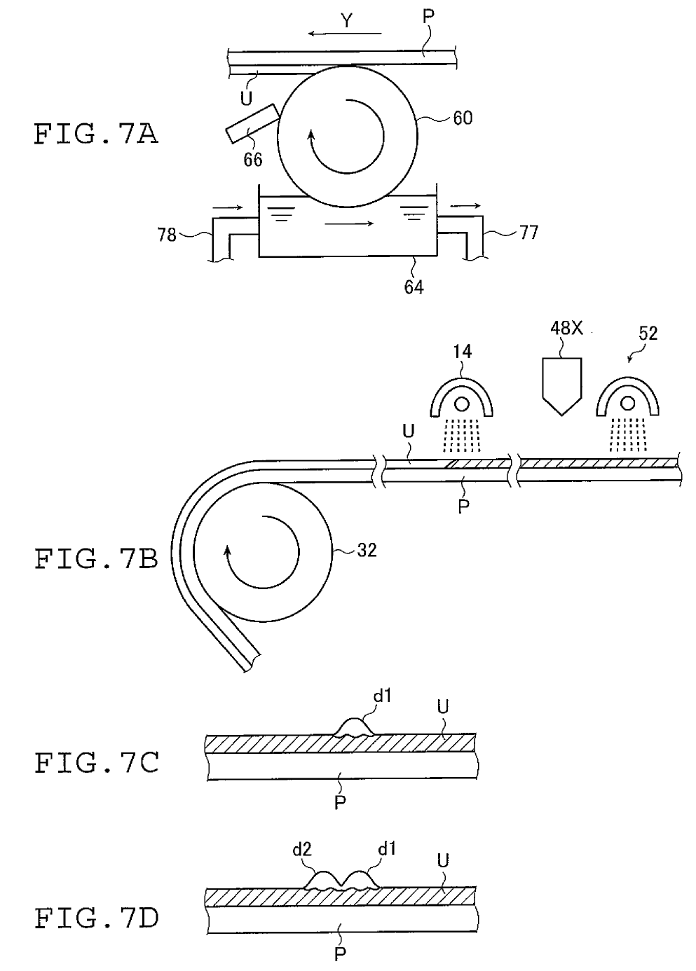

FIGS. 7A to 7D are views schematically showing steps of forming an image on a recording medium, respectively.

The recording medium P having been let out from the feed roll 30 is transported in a specified direction (direction “Y” in FIG. 1) by rotation of the transport roll 32 and the transport roller pair 34. As described above, the recording medium P in this embodiment is a web with a certain length or more and is transported without being cut.

As shown in FIG. 7A, the recording medium P having been let out from the feed roll 30 comes into contact with the coating roll 60 of the undercoat forming section 13 and the undercoating liquid is applied onto the surface thereof to form an undercoat U. The drive unit 62 causes the coating roll 60 to rotate in the direction opposite to the direction of travel of the recording medium P. The undercoating liquid within the reservoir 64 in which the coating roll 60 is immersed is flowed in the direction opposite to the direction of rotation of the coating roll 60 as it is vibrated.

The recording medium P on which the undercoat U has been formed by application of the undercoating liquid is further transported by the transport roll 32 and the transport roller pair 34 of the transport section 12 and passes through the position facing the undercoating liquid semi-curing section 14.

As shown in FIG. 7B, the undercoating liquid semi-curing section 14 irradiates with ultraviolet light, the recording medium P onto which the undercoating liquid has been applied and which is passing through the position facing the section 14, thereby semi-curing the undercoat U on the recording medium P.

The recording medium P having thereon the semi-cured undercoating liquid is further transported by the transport roll 32 and the transport roller pair 34 of the transport section 12 and passes through the position facing the recording head 48X.

The recording head 48X ejects ink droplets from its ejection orifices to form an image on the recording medium P which is being transported by the transport section 12 and passing through the position opposed thereto.

More specifically, the recording head 48X ejects a first ink droplet d1 onto the recording medium P. As shown in FIG. 7C, the first ink droplet d1 ejected from the recording head 48X is deposited onto the surface of the undercoat U. The undercoat U is in a semi-cured state and has an uncured surface, and is therefore receptive to the ink droplet d1.

As shown in FIG. 7D, the recording head 48X ejects a second ink droplet d2 in proximity to the position where the previously ejected first ink droplet d1 was deposited. In this case, the undercoat U is also in a semi-cured state and has an uncured surface, and is therefore receptive to the ink droplet d2.

In the case where the ink droplets d1 and d2 have been deposited in proximity to each other on the recording medium P, a force acts to make the ink droplets d1 and d2 coalesce, but interference between the ink droplets having been deposited onto the recording medium P is suppressed by the resistance force of the undercoat U against coalescence of the ink droplets because the undercoat U is semi-cured and has an increased viscosity.

Ink droplets are thus ejected from the recording head 48X in accordance with the control by the control unit 20 and deposited onto the recording medium P to form an image.

The recording medium P having the image formed by the recording head 48X is further transported by the transport section 12 and passes through the position facing the UV irradiation unit 52X disposed downstream from the recording head 48X.

The UV irradiation unit 52X irradiates the recording medium P passing through the position opposed thereto with ultraviolet light to semi-cure the image formed by the recording head 48X on the recording medium P, that is, semi-cure the ink droplets having been deposited onto the recording medium P.

Thereafter, the recording medium P is further transported and passes in order through the positions facing the recording head 48Y, the UV irradiation unit 52Y, the recording head 48C, the UV irradiation unit 52C, the recording head 48M, the UV irradiation unit 52M, and the recording head 48K, respectively. As in the case where the recording medium P passed through the positions facing the recording head 48X and its corresponding UV irradiation unit 52X, formation of an image and semi-curing of the formed image are performed each time the recording medium P passes through the positions facing the recording head of each color and its corresponding UV irradiation unit.

After an image has been formed by the recording head 48K, the recording medium P passes through the position facing the final UV irradiation unit for curing 54.

The final UV irradiation unit for curing 54 irradiates the recording medium P with more intense ultraviolet light than the other UV irradiation units to cure the whole of the images on the recording medium P formed by the various recording heads including the image recorded by the recording head 48K as well as the undercoating liquid.

A color image is thus formed on the recording medium P.

The recording medium P having the color image formed thereon is further transported by the transport roll 32 and the transport roller pair 34 to be taken up onto the recovery roll 36.

The ink-jet recording device 10 thus forms images on the recording medium P.

By thus forming the undercoat on the recording medium P with the ink-jet recording device 10, the ink droplets having been deposited onto the recording medium can be prevented from permeating the recording medium to cause image bleed, thus enabling a high-resolution image to be formed. It also becomes possible to use a recording medium which has a low adhesion to ink droplets, namely, may repel ink droplets having been deposited thereonto. In other words, image recording on various recording media becomes possible.

A so-called gravure roll is used for the coating roll 60, and the circulating unit 74 is activated to circulate (i.e., flow and move) the undercoating liquid within the reservoir 64 at a predetermined speed in the direction opposite to the direction of rotation of the coating roll 60 while at the same the ultrasonic generator 76 is activated to apply ultrasonic waves to the undercoating liquid within the reservoir 64 to vibrate the undercoating liquid to thereby promote the supply of the liquid to the cells of the gravure roll used as the coating roll 60 and the replacement of the liquid in the cells even in the case of a high coating rate and/or a high undercoating liquid viscosity, thus enabling the surface of the coating roll 60 immersed in the reservoir 64 to uniformly receive the undercoating liquid, which ensures that the portion of the coating roll 60 which comes into contact with the recording medium P retains a fixed amount of the undercoating liquid to achieve uniform coating of the undercoating liquid onto the recording medium P.

In other words, the undercoat forming section 13 can uniformly coat the highly viscous undercoating liquid onto the recording medium P at a high speed to form a higher-resolution image at a higher speed. Even in the case of using a less permeable medium as the recording medium, use of the highly viscous undercoating liquid can prevent the undercoating liquid from permeating the recording medium to achieve formation of a high-resolution image.

By rotating the coating roll 60 in the direction opposite to the direction of travel of the recording medium P at the portion of contact therebetween to coat the undercoating liquid onto the recording medium P, disruption of the surface of the undercoating liquid on the recording medium P can be prevented from occurring when the coating roll 60 separates from the recording medium P after having coated the undercoating liquid thereon, enabling the undercoat U having an improved surface state to be formed on the recording medium P.

By semi-curing the undercoat in the undercoating liquid semi-curing section as in the present embodiment, even when ink droplets deposited on the recording medium have portions which mutually overlap, the coalescence of these neighboring ink droplets can be suppressed through interactions between the undercoating liquid and the ink droplets.

That is, by forming a semi-cured undercoat on the recording medium, the migration of ink droplets can be prevented in cases where ink droplets ejected from the recording heads are deposited in close proximity on the recording medium, such as when ink droplets of a single color deposited on a recording medium have portions which mutually overlap or even when ink droplets of different colors deposited on a recording medium have portions which mutually overlap.

In this way, image bleed, line width non-uniformities such as of fine lines in the image, and color unevenness on colored surfaces can be effectively prevented from occurring, enabling the formation of uniform-width, sharp line shapes, and thus making it possible to carry out the recording of ink-jet images of a high deposition density, such as reversed letters, with good reproducibility of fine features such as fine lines. That is, high-resolution images can be formed on the recording medium.

By placing a UV irradiation unit between the respective recording heads and semi-curing the ink droplets deposited onto (i.e., the image formed on) the recording medium using the respective recording heads as in the embodiment under consideration, it is possible to prevent different-color ink droplets deposited at adjacent positions from overlapping and to keep the deposited ink droplets from migrating.

On the travel path of the recording medium, the UV irradiation unit corresponding to the recording head disposed on the furthest downstream side serves as the final UV irradiation unit for curing and, because it emits higher intensity UV light than the other UV irradiation units, has the ability to reliably cure images that have been formed on the recording medium.

The ink-jet recording device 10 circulates the undercoating liquid within the reservoir 64 by means of the circulating unit 74 to flow it at a predetermined speed in the direction opposite to the direction of rotation of the coating roll 60, but this is not the sole case of the invention. The undercoating liquid in the region of the reservoir 64 where it contacts the coating roll 60 may be flowed at a predetermined speed in the direction opposite to the direction in which the coating roll 60 is rotated. For example, although the amount of undercoating liquid consumed is increased, the undercoating liquid may be continuously flowed in a fixed direction instead of being circulated. Alternatively, the undercoating liquid may be circulated within the reservoir. More specifically, the undercoating liquid may be flowed about the rotational axis passing through the center of the reservoir 74 in the order of the liquid upper side, the lateral side (in the direction from the liquid upper side to the bottom side), the bottom side (in the direction opposite to that of the flow on the liquid upper side) and the lateral side (in the direction from the bottom side to the liquid upper side).

The circulating unit 74, that is, liquid flow generating unit preferably forms a flow of the undercoating liquid having a flow rate of at least 5 mm/s in the region where the undercoating liquid contacts the coating roll, which further ensures that the undercoating liquid is uniformly applied to the surface of the coating roll to prevent nonuniformity in the undercoating liquid applied to the coating roll from occurring.

This embodiment offers a simple layout and allows vibrations to be applied with high precision, so that ultrasonic waves are applied from the ultrasonic generator to the undercoating liquid to vibrate the undercoating liquid. However, the vibrating method is not particularly limited and other mechanical vibration generating mechanisms using an eccentric motor, piezoelectric device and the like may be employed to vibrate the reservoir and hence the undercoating liquid held therein.

The undercoating liquid in the reservoir is vibrated because the coating roll can receive the undercoating liquid more reliably. However, a vibration generating mechanism may be used to vibrate the coating roll.

The ultrasonic generator and/or the vibration generating mechanism is preferably provided so that the coating roll can more reliably receive the undercoating liquid but is not the essential component.

In the embodiment under consideration, the undercoating liquid in the region of the reservoir where it contacts the coating roll is flowed in the direction opposite to the direction of rotation of the coating roll at the portion of contact therebetween to allow it to be uniformly picked up by the coating roll, but the means for promoting the supply of the undercoating liquid to the coating roll is not limited to this.

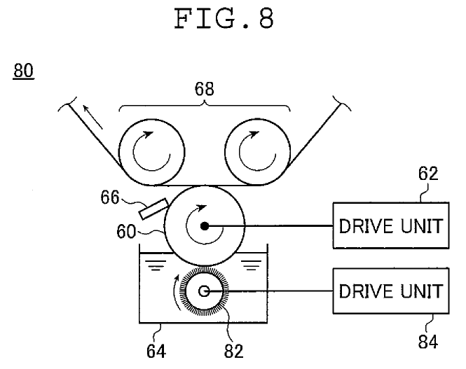

FIG. 8 is a front view schematically showing the structure of another example of the undercoat forming section for which the coater of the present invention is used. An undercoat forming section 80 is configured in the same manner as the undercoat forming section 13 except that a brush 82 and a brush drive unit 84 are provided as means for promoting feed of the undercoating liquid to the coating roll instead of the circulating unit 74 and the ultrasonic generator 76. Like elements in the undercoat forming section 13 are thus denoted by the same reference symbols and repeated explanations of such elements are omitted. The following description focuses on the distinctive features of the undercoat forming section 80.

As shown in FIG. 8, the undercoat forming section 80 has a coating roll 60 for coating an undercoating liquid onto the recording medium P, a drive unit 62 which drives the coating roll 60, a reservoir (liquid holding vessel) 64 which supplies the undercoating liquid to the coating roll 60, a blade 66 which adjusts the amount of undercoating liquid picked up by the coating roll 60, a positioning unit 68 which supports the recording medium P so that the recording medium P assumes a predetermined position relative to the coating roll 60, a brush 82 which is provided within the reservoir 64 and urges the undercoating liquid to be picked up by the coating roll, and a brush drive unit 84 which rotates the brush 82 (the brush drive unit 84 being hereinafter referred to simply as the “drive unit 84”).

The brush 82 is a member having a multiplicity of linear bristles with a predetermined length and a predetermined hardness disposed on the roll surface and is set within the region of the reservoir 64 where the undercoating liquid is held so that the linear bristles are in contact with the coating roll 60. The linear bristles of the brush 82 are made of a flexible material which bends upon contact with the coating roll 60.

The drive unit 84 is a drive mechanism including a motor, and gears which transmit rotation of the motor to the brush 82 and rotates the brush 82. The drive unit 84 may be connected to the brush 82 disposed within the undercoating liquid. Alternatively, the drive unit 84 may also be connected to the portion of the brush 82 which emerges from the reservoir 64 after moving the rotating shaft of the brush 82 out of the reservoir 64.

The drive unit 84 is also not limited to the present embodiment. Any of various other drive mechanisms may instead be used to rotate the brush 82, including pulley driving, belt driving and direct driving.

As arrows in FIG. 8 show, the drive unit 84 rotates the brush 82 in the same direction as the rotational direction of the coating roll 60 (in the clockwise direction in FIG. 8).

In the foregoing arrangement of the undercoat forming section 80, the coating roll 60 a part of which is immersed in the undercoating liquid within the reservoir 64 as in the undercoat forming section 13 is rotated to coat the recording medium P with the undercoating liquid.

The portion of the coating roll 60 which is immersed in the undercoating liquid within the reservoir 64 is in contact with the linear bristles of the brush 82 which is rotated by the drive unit 84 in the same direction as the direction of rotation of the coating roll 60 (i.e., moved in the opposite direction at the portion of contact between the coating roll 60 and the brush 82). Rotation of the brush 82 enables the number of linear bristles contacting the coating roll 60 to be increased while flowing the undercoating liquid in the region of contact with the coating roll in the direction opposite to the direction of rotation of the coating roll.

By bringing the portion of the coating roll 60 immersed in the undercoating liquid into contact with the linear bristles of the brush 82 which is moving in the opposite direction at the portion of contact therebetween, the undercoating liquid can be brought into contact with the coating roll 60 with advantage as air bubbles produced on the surface of the coating roll 60 are being removed, whereby the coating liquid can be uniformly picked up by the coating roll 60.

Even at a high coating rate and/or a high undercoating liquid viscosity, the surface of the coating roll 60 can uniformly receive the undercoating liquid by providing the brush so that its linear bristles come into contact with the coating roll.

It is preferable for the brush 82 to be rotated in the same direction as the direction of rotation of the coating roll 60 as in this embodiment.

Rotation of the brush 82 and the coating roll 60 in the same direction enables the liquid to be supplied to the cells of the coating roll 60 in an improved manner so that the coating roll 60 can more uniformly receive the undercoating liquid.

The higher the viscosity of the undercoating liquid within the reservoir 64 is, the more the level of the undercoating liquid on the downstream side in the direction of rotation of the coating roll 60 is increased as a result of its rotation. However, rotation of the brush 82 and the coating roll 60 in the same direction suppresses an increase in the liquid level on the downstream side in the rotational direction of the coating roll 60 to prevent the undercoating liquid from leaking out of the reservoir 64.

Considering that a liquid flow can be formed, the coating roll 60 can receive the undercoating liquid more uniformly and that the undercoating liquid can be advantageously prevented from leaking out of the reservoir 64, the brush 82 is rotated by the drive unit 84 in this embodiment. However, the brush 82 may be fixed.

The undercoating liquid has a viscosity of preferably at least 10 mPa·s but not more than 500 mPa·s, and more preferably at least 50 mPa·s but not more than 300 mPa·s.

At an undercoating liquid viscosity of at least 10 mPa·s, and more preferably at least 50 mPa·s, as noted above, it is possible to coat the undercoating liquid onto even a recording medium to which liquid does not readily adhere.

At an undercoating liquid viscosity of not more than 500 mPa·s, and more preferably not more than 300 mPa·s, it is possible to more reliably achieve a lower surface roughness in the undercoat that is formed on the recording medium P.

As will be described later, the present invention can form a uniform undercoat at a high speed even in the case where a high-viscosity undercoating liquid is used as the undercoating liquid.

It is also preferable to set the velocity at which the recording medium P is transported by the transport section 12 to at least 100 mm/s but not more than 1000 mm/s. In this way, high-resolution images can be efficiently formed on the recording medium. Moreover, prints can be produced at a high speed. That is, a large amount of recording medium can be printed in a short time.

It is preferred to irradiate the recording medium with ultraviolet light in a period of several hundred milliseconds to 5 seconds after the ink droplets have been deposited from the recording head on the recording medium to semi-cure the ink droplets deposited thereon.

By thus semi-curing the ink droplets in the period of several hundred milliseconds to 5 seconds after their deposition, the ink droplets on the recording medium can be prevented from getting out of shape, enabling a high-resolution image to be formed.

It is preferable to provide a positioning mechanism for fixing the mutual positions of the coating roll 60, the first positioning roll 70 and the second positioning roll 72 in the undercoat forming section 13. By thus providing the positioning mechanism, departures from the correct positional relationships between the coating roll 60 and the positioning rolls 70 and 72 can be prevented from occurring.

Any positioning mechanism may be used as long as it is configured such that members which individually support the coating roll 60 and the first and second positioning rolls 70 and 72 are placed in mutual contact. For example, use may be made of a mechanism in which the bearings of the respective members are placed in mutual contact, and a mechanism in which fixing members which fix in place the bearings are placed in mutual contact.

In the present embodiment, by disposing UV irradiation units between recording heads of the respective ink colors and curing the image areas on the recording medium each time an image is recorded at each of the recording heads, as noted above, it is possible to prevent ink of different colors from intermingling, thus enabling higher resolution images to be formed. Accordingly, a UV irradiation unit was positioned at each of the recording heads. However, the present invention is not limited in this regard. To illustrate, in an alternative arrangement, a single UV irradiation unit may be disposed for a plurality of recording heads. To be more specific, the image fixing section 18 may only be composed of the final UV irradiation unit for curing 54.

In the present embodiment, the recording head unit has recording heads of a total of five colors consisting of a special color (X), yellow (Y), cyan (C), magenta (M) and black (K). However, it is also possible to employ a recording head unit having other combinations of heads, including a recording head unit having heads for only the four colors CMYK, or a recording head unit having heads for six or more colors, including another special color head. The recording heads of the respective colors may be disposed in any order without any particular limitation.

Nor is the invention limited to requiring the disposition of a plurality of recording heads. That is, the ink-jet recording device of the invention may be one which uses a single recording head to form an image on the recording medium, then irradiates the image with UV light to form a single-color image.

### EXAMPLES

The invention is described below in further detail with reference to measurement examples.

### Example 1

The coating roll used for the measurement was a roll with a diameter of 60 mm formed in such a manner that recesses were spaced at a density of 150 lines/inch, and the recesses had an oblique line shape and a depth of 30 μm. The coating roll was rotated so that its circumferential speed was the same as the speed at which the recording medium (base material) traveled. The coating roll was rotated in the direction opposite to the direction of travel of the recording medium at the portion of contact therebetween.

Undercoating liquids having viscosities of 10 cP, 30 cP, 40 cP, 50 cP, 100 cP and 200 cP were prepared. These undercoating liquids were coated at varying coating rates (i.e., at varying speeds of travel of the recording medium P) of 100 mm/s, 200 mm/s, 400 mm/s and 600 mm/s to form undercoats and their surface states were observed.

As a result of the observation, the surface state was rated “good” when no uneven streaks occurred due to short supply of the undercoating liquid to the coating roll cells and “poor” when uneven streaks occurred due to short supply of the undercoating liquid.

### Example 1

In Example 1, a device having the undercoat forming section 13 arranged as shown in FIG. 1 was used, and ultrasonic waves were applied from the ultrasonic generator to the undercoating liquid being circulated at a flow rate of 10 mm/s by means of the circulating unit 74, thus vibrating the undercoating liquid within the reservoir 64. Measurement was made in this case. The ultrasonic generator applied ultrasonic waves at a frequency of 30 kHz.

The measurement results are shown in Table 1.

TABLE 1

Coating rate

| Viscosity | 100 mm/s | 200 mm/s | 400 mm/s | 600 mm/s |
|---|---|---|---|---|
| 10 cP | Good | Good | Good | Good |
| 30 cP | Good | Good | Good | Good |
| 40 cP | Good | Good | Good | Good |
| 50 cP | Good | Good | Good | Poor |
| 100 cP | Good | Good | Poor | Poor |
| 200 cP | Good | Poor | Poor | Poor |

### Example 2

Then, in Example 2, a device having the undercoat forming section 13 arranged as shown in FIG. 1 was used and ultrasonic waves were applied from the ultrasonic generator to the undercoating liquid being circulated at a flow rate of 30 mm/s by means of the circulating unit 74, thus vibrating the undercoating liquid within the reservoir 64. Measurement was made in this case.

The measurement results are shown in Table 2.

TABLE 2

Coating rate

| Viscosity | 100 mm/s | 200 mm/s | 400 mm/s | 600 mm/s |
|---|---|---|---|---|
| 10 cP | Good | Good | Good | Good |
| 30 cP | Good | Good | Good | Good |
| 40 cP | Good | Good | Good | Good |
| 50 cP | Good | Good | Good | Good |
| 100 cP | Good | Good | Good | Good |
| 200 cP | Good | Good | Good | Good |

### Example 3

Then, in Example 3, a device having the undercoat forming section 13 arranged as shown in FIG. 1 was used and the undercoating liquid was circulated at a flow rate of 30 mm/s by means of the circulating unit 74 without applying ultrasonic waves from the ultrasonic generator. Measurement was made in this case.

The measurement results are shown in Table 3.

TABLE 3

Coating rate

| Viscosity | 100 mm/s | 200 mm/s | 400 mm/s | 600 mm/s |
|---|---|---|---|---|
| 10 cP | Good | Good | Good | Good |
| 30 cP | Good | Good | Good | Good |
| 40 cP | Good | Good | Good | Good |
| 50 cP | Good | Good | Good | Poor |
| 100 cP | Good | Good | Poor | Poor |
| 200 cP | Good | Poor | Poor | Poor |

Then, in Example 4, a device having the undercoat forming section 80 arranged as shown in FIG. 8 was used, and the brush 82 was rotated at a circumferential speed of 50 mm/s by the drive unit 84. Measurement was made in this case. A roll brush having a length from its center to the linear bristle tip of 15 mm was used as the brush 82 and the distance between the center of rotation of the brush and the center of the coating roll was set to 44 mm.

The measurement results are shown in Table 4.

TABLE 4

Coating rate

| Viscosity | 100 mm/s | 200 mm/s | 400 mm/s | 600 mm/s |
|---|---|---|---|---|
| 10 cP | Good | Good | Good | Good |
| 30 cP | Good | Goad | Good | Good |
| 40 cP | Good | Good | Good | Good |
| 50 cP | Good | Good | Good | Good |
| 100 cP | Good | Good | Good | Good |
| 200 cP | Good | Good | Good | Good |

### Example 5

Then, in Example 5, a device having the undercoat forming section 80 arranged as shown in FIG. 8 was used and the brush 82 was not rotated by the drive unit 84 but was fixed. Measurement was made in this case. A roll brush having a length from its center to the linear bristle tip of 15 mm was used as the brush 82 and the distance between the center of rotation of the brush and the center of the coating roll was set to 44 mm.

The measurement results are shown in Table 5.

TABLE 5

Coating rate

| Viscosity | 100 mm/s | 200 mm/s | 400 mm/s | 600 mm/s |
|---|---|---|---|---|
| 10 cP | Good | Good | Good | Good |
| 30 cP | Good | Good | Good | Good |
| 40 cP | Good | Good | Good | Good |
| 50 cP | Good | Good | Good | Poor |
| 100 cP | Good | Good | Poor | Poor |
| 200 cP | Good | Poor | Poor | Poor |

### Comparative Example 1

In Comparative Example 1, a device having the undercoat forming section 13 arranged as shown in FIG. 1 was used, no liquid flow was generated in the undercoating liquid within the reservoir, no ultrasonic waves were applied, and no brush was provided. Measurement was made in this case.

The measurement results are shown in Table 6.

TABLE 6

Coating rate

| Viscosity | 100 mm/s | 200 mm/s | 400 mm/s | 600 mm/s |
|---|---|---|---|---|
| 10 cP | Good | Good | Good | Poor |
| 30 cP | Good | Poor | Poor | Poor |
| 40 cP | Poor | Poor | Poor | Poor |
| 50 cP | Poor | Poor | Poor | Poor |
| 100 cP | Poor | Poor | Poor | Poor |
| 200 cP | Poor | Poor | Poor | Poor |

### Comparative Example 2

In Comparative Example 2, a device having the undercoat forming section 13 arranged as shown in FIG. 1 was used and ultrasonic waves were applied from the ultrasonic generator to the undercoating liquid within the reservoir where no liquid flow was generated, thus vibrating the undercoating liquid within the reservoir 64. Measurement was made in this case.

The measurement results are shown in Table 7.

TABLE 7

Coating rate

| Viscosity | 100 mm/s | 200 mm/s | 400 mm/s | 600 mm/s |
|---|---|---|---|---|
| 10 cP | Good | Good | Good | Good |
| 30 cP | Good | Good | Good | Good |
| 40 cP | Good | Good | Poor | Poor |
| 50 cP | Good | Poor | Poor | Poor |
| 100 cP | Good | Poor | Poor | Poor |
| 200 cP | Poor | Poor | Poor | Poor |

Tables 1 to 7 show that, as compared with the cases where no liquid flow was generated, the undercoating liquid can be uniformly coated even at a higher coating rate and/or a higher undercoating liquid viscosity by using the process which involved flowing the undercoating liquid in its region of contact with the coating roll within the reservoir in the direction opposite to the direction of rotation of the coating roll and applying ultrasonic waves from the ultrasonic generator to the undercoating liquid.

Tables 1 to 7 also show that, as compared with the case where no brush was provided, the undercoating liquid can be uniformly coated even at a higher coating rate and/or a higher undercoating liquid viscosity by disposing the brush in the undercoating liquid within the reservoir so as to contact the coating roll and rotating it in the same direction as that of rotation of the coating roll.

Tables 2 and 3 show that the process which involved flowing the undercoating liquid in its region of contact with the coating roll within the reservoir in the direction opposite to the rotational direction of the coating roll without ultrasonic vibrations is less effective, but the undercoating liquid can still be uniformly coated even at a higher coating rate and/or a higher undercoating liquid viscosity as compared with the cases where no liquid flow was generated.

Tables 4 and 5 show that the process in which the brush disposed in the undercoating liquid within the reservoir so as to contact the coating roll was not rotated but fixed is less effective, but the undercoating liquid can still be uniformly coated even at a higher coating rate and/or a higher undercoating liquid viscosity as compared with the cases where no brush was provided.

From these results, the advantageous effects of the present invention are obvious.

Recording media, undercoats and inks that may be used with advantage in the ink-jet recording device of the invention are described below.

(Physical Properties of Ink and Undercoat liquid)

The physical properties of the ink (droplets) ejected onto the recording medium will differ with the device, although in general the viscosity at 25° C. is preferably from 5 to 100 mPa·s, and more preferably from 10 to 80 mpa·s. The viscosity at 25° C. before internal curing of the undercoat liquid is preferably from 10 to 500 mPa·s, and more preferably from 50 to 300 mPa·s.

In the practice of the invention, in order to form dots of the intended size on the recording medium, it is preferable for the undercoat liquid to include a surfactant, and more preferable that it satisfy conditions (A), (B) and (C) below.
(A) The undercoat liquid has a lower surface tension than any of the inks ejected onto the recording medium.
(B) At least one surfactant included in the undercoat liquid satisfies the relationship

γs (0)−γs (saturation)>0 (mN/m)
(C) The surface tension of the undercoat liquid satisfies the relationship

γs<(γs (0)+γs (saturation)^{max})/2.

Here, γs represents the surface tension of the undercoat liquid, γs (0) is the surface tension of the liquid from which all the surfactants in the undercoat liquid composition have been excluded, γs (saturation) is the surface tension of the liquid obtained by adding one of the surfactants included in the undercoat liquid to the above “liquid from which all the surfactants in the undercoat liquid composition have been excluded” and increasing the concentration of that surfactant until the surface tension reaches saturation, and γs (saturation)^{max} is the largest of the γs (saturation) values obtained for all the surfactants included in the undercoat liquid that satisfy above condition (B).

### Condition (A):

In the practice of the invention, as explained above, to form ink dots of the desired size on the recording medium, it is preferable for the surface tension γs of the undercoat liquid to be lower than the surface tension γk of any of the inks.

Also, to more effectively prevent expansion of the ink dots in the time interval between deposition and exposure, it is more preferable for γs<γk−3 (mN/m), and even more preferable for γs<γk−5 (mN/m).

When a full-color image is formed (printed), to enhance the sharpness of the image, the surface tension γs of the undercoat liquid is preferably lower than the surface tension of an ink containing a colorant having a high luminosity factor, and more preferably lower than the surface tension of all inks. Examples of colorants having a high luminosity factor include colorants which have magenta, black and cyan colors.

Moreover, for proper ejection, the ink surface tension γk and the undercoat liquid surface tension γs should satisfy the above-indicated relationship, with each being preferably within a range of from 15 to 50 mN/m, more preferably within a range of from 18 to 40 mN/m, and most preferably within a range of from 20 to 38 mN/m.

By having the surface tensions for both the ink and the undercoat liquid be at least 15 mN/m, the ink droplets to be ejected by the ink-jet heads can be suitably formed, making it possible to prevent improper ejection from occurring. That is, the ink droplets can be suitably ejected. Also, by having the surface tensions for both the undercoat liquid and the ink be up to 50 mN/m, the wettability with the ink-jet heads can be increased, enabling suitable ejection of the ink droplets. That is, the improper ejection of droplets can be prevented from occurring. By having the surface tensions for both be within a range of from 18 to 40 mN/m, and especially within a range of from 20 to 38 mN/m, the above effects can be better achieved and the ink droplets can be reliably ejected.

In the present embodiment, the surface tensions are values measured by the Wilhelmy plate method at a liquid temperature of 20° C. and 60% relative humidity using a commonly used surface tensiometer (e.g., the CBVP-Z surface tensiometer manufactured by Kyowa Interface Science Co., Ltd.).

### Conditions (B) and (C):

In the present invention, the undercoat liquid preferably includes one or more surfactants. By including one or more surfactants in the undercoat liquid, ink dots of the desired size can be more reliably formed on the recording medium. Moreover, it is preferable for the one or more surfactants included in the undercoat liquid to satisfy the following condition (B).

γs (0)−γs (saturation)>0 mN/m Condition (B):

In addition, it is preferable for the surface tension of the undercoat liquid to satisfy the following condition (C).

γs<(γs (0)+γs (saturation)^{max})/2 Condition (C):

As mentioned above, γs represents the surface tension of the undercoat liquid, γs (0) is the surface tension of the liquid from which all the surfactants in the undercoat liquid composition have been excluded, γs (saturated) is the surface tension of the liquid obtained by adding one of the surfactants included in the undercoat liquid to the above “liquid from which all the surfactants in the undercoat liquid composition have been excluded” and increasing the concentration of that surfactant until the surface tension reaches saturation, and γs (saturation)^{max} is the largest of the γs (saturation) values obtained for all the surfactants included in the undercoat liquid that satisfy above condition (B).

The above γs (0) value is obtained by measuring the surface tension of the liquid from which all the surfactants in the undercoat liquid composition have been excluded. The above γs (saturation) value is obtained by adding to the above “liquid from which all the surfactants in the undercoat liquid composition have been excluded” one of the surfactants included in the undercoat liquid and, while increasing the concentration of that surfactant present in the liquid in increments of 0.01 wt %, measuring the surface tension of the liquid when the amount of change in surface tension with respect to the change in surfactant concentration falls below 0.01 mN/m.

The above values of γs (0), γs (saturation) and γs (saturation)^{max} are described more fully below.

For example, when the ingredients making up the undercoat liquid (Example 1) are a high-boiling solvent (diethyl phthalate, available from Wako Pure Chemical Industries, Ltd.), a polymerizable material (dipropylene glycol diacrylate; available from Akcros Chemicals Ltd.), a polymerization initiator (TPO, Initiator 1 shown below), a fluorocarbon surfactant (Megaface F475, available from Dainippon Ink & Chemicals, Inc.) and a hydrocarbon surfactant (sodium di-(2-ethylhexyl)sulfosuccinate), the γs (0), γs (saturation)¹ (when a fluorocarbon surfactant has been added), γs (saturation)² (when a hydrocarbon surfactant has been added), γs (saturation) and γs (saturation)^{max} values are as indicated below.

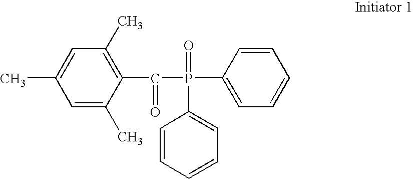

Namely, the value for γs (0), which is the surface tension of the liquid from which all the surfactants in the undercoat liquid have been excluded, is 36.7 mN/m. When the above fluorocarbon surfactant is added to this liquid, the saturation value γs (saturation)¹ for the surface tension of the liquid when the surfactant concentration has been increased is 20.2 mN/m. Similarly, when the hydrocarbon surfactant is added to this liquid, the saturation value γs (saturation)² for the surface tension of the liquid when the surfactant concentration has been increased is 30.5 mN/m.

Because the undercoat liquid (Example 1) includes two types of surfactants which satisfy above condition (B), γs (saturation) can have two values: one for when a fluorocarbon surfactant is added (γs saturation)¹, and another for when a hydrocarbon surfactant is added (γs (saturation)². Because γs (saturation)^{max} is the largest value among γs (saturation)¹ and γs (saturation)², in this case it is the γs (saturation)² value.

The above values are summarized below.

γs (0)−36.7 mN/m

γs (saturation)=20.2 mN/m (when fluorocarbon surfactant is added)

γs (saturation)²=30.5 mN/m (when hydrocarbon surfactant is added)

γs (saturation)^{max}=30.5 mN/m

From the above results, it is preferable for the surface tension γs of the undercoat liquid in the foregoing example to satisfy the following relationship:

γs<(γs (0)+γs (saturation)^{max})/2=33.6 mN/m.

With regard to above condition (C), to more effectively prevent ink droplet expansion during the period between deposition and exposure, it is preferable for the surface tension of the undercoat liquid to satisfy the relationship:

γs<γs (0)−3×{γs (0)−γs (saturation)^{max}}/4,

and especially preferable for it to satisfy the relationship:

γs≦γs (saturation)^{max}.

While it suffices for the compositions of the ink and the undercoat liquid to be selected so that the desired surface tension is obtainable, it is preferable for these liquids to include a surfactant. As already explained, to form ink dots of the desired size on the recording medium, it is preferable for the undercoat liquid to include at least one surfactant. A description of the surfactant follows below.

### (Surfactant)

The surfactant used in the invention is typically a substance having a strong surface activity with respect to at least one solvent from among hexane, cyclohexane, p-xylene, toluene, ethyl acetate, methyl ethyl ketone, butyl carbitol, cyclohexanone, triethylene glycol monobutyl ether, 1,2-hexanediol, propylene glycol monomethyl ether, isopropanol, methanol, water, isobornyl acrylate, 1,6-hexanediol diacrylate and polyethylene glycol diacrylate; preferably a substance having a strong surface activity with respect to at least one solvent from among hexane, toluene, propylene glycol monomethyl ether, isobornyl acrylate, 1,6-hexanediol diacrylate and polyethylene glycol diacrylate; more preferably a substance having a strong surface activity with respect to at least one solvent from among propylene glycol monomethyl ether, isobornyl acrylate, 1,6-hexanediol diacrylate and polyethylene glycol diacrylate; and most preferably a substance having a strong surface activity with respect to at least one solvent from among isobornyl acrylate, 1,6-hexanediol diacrylate and polyethylene glycol diacrylate.

Whether or not a particular compound is a substance having a strong surface activity with respect to the solvents listed above can be determined by the following procedure.

One solvent is selected from the solvents listed above, and the surface tension γₛₒₗᵥₑₙₜ (0) for that solvent is measured. The compound is added to the same solvent as that for which γₛₒₗᵥₑₙₜ (0) was determined and, as the concentration of the compound is increased in increments of 0.01 wt %, the surface tension γₛₒₗᵥₑₙₜ (saturation) of the solution when the change in surface tension with respect to the change in compound concentration falls below 0.01′ mN/m is measured. If the relationship between γₛₒₗᵥₑₙₜ (0) and γₛₒₗᵥₑₙₜ (saturation) satisfies the condition

γₛₒₗᵥₑₙₜ (0)−γₛₒₗᵥₑₙₜ (saturation)>1 (mN/m)

it can be concluded that the compound is a substance having a strong surface activity with respect to the solvent.

Specific examples of surfactants which may be included in the undercoat liquid include anionic surfactants such as dialkylsulfosuccinic acid salts, alkylnaphthalenesulfonic acid salts, and fatty acid salts; nonionic surfactants such as polyoxyethylene alkyl ethers, polyoxyethylene alkylallyl ethers, acetylene glycols and polyoxyethylene polyoxypropylene block copolymers; cationic surfactants such as alkylamine salts and quaternary ammonium salts; and fluorocarbon surfactants. Other suitable surfactants include those mentioned in, for example, JP 62-173463 A and JP 62-183457 A.

(Cure Sensitivity of Ink and Undercoat liquid)

In the practice of the invention, the cure sensitivity of the ink is preferably comparable to or higher than the cure sensitivity of the undercoat liquid. The cure sensitivity of the ink is more preferably higher than the cure sensitivity of the undercoat liquid but not more than four times the cure sensitivity of the undercoat liquid, and even more preferably higher than the cure sensitivity of the undercoat liquid but not more than two times the cure sensitivity of the undercoat liquid.

As used herein, “cure sensitivity” refers to the amount of energy required for complete curing when the ink and/or the undercoat liquid is cured using a mercury vapor lamp (e.g., an ultrahigh-pressure, high-pressure or moderate-pressure mercury-vapor lamp; preferably an ultrahigh-pressure mercury vapor lamp). A smaller amount of energy means a higher cure sensitivity. Accordingly, a two-fold cure sensitivity means that the amount of energy required for complete curing is one-half as large.

Also, reference herein to a cure sensitivity as being “comparable” signifies that the difference in the cure sensitivities of the two liquids being compared is less than 2-fold, and preferably less than 1.5-fold.

### (Recording Medium)

The recording medium used in the ink-jet recording device of the present embodiment may be a permeable recording medium, an impermeable recording medium or a slowly permeable recording medium. Of these, the advantageous effects of the invention can be more clearly achieved with the use of an impermeable or slowly permeable recording medium. As used herein, “permeable recording medium” refers to a recording medium in which, when a 10 pL (picoliter) droplet is deposited on the recording medium, permeation of all the liquid takes not more than 100 ms. “Impermeable recording medium” refers herein to a recording medium in which a droplet substantially does not permeate. “Substantially does not permeate” connotes here a permeability of a droplet after 1 minute of not more than 5%. Also, “slowly permeable recording medium” refers herein to a recording medium in which, when a 10 pL droplet is deposited on the recording medium, permeation of all the liquid takes 100 ms or more.

Illustrative examples of permeable recording media include plain paper, porous paper, and recording media capable of absorbing other liquids.

Illustrative examples of impermeable or slowly permeable recording media include art paper, plastic, rubber, resin-coated paper, glass, metal, ceramic and wood. In the practice of the invention, composite recording media in which a plurality of these materials are combined may also be used for the purpose of adding the functionality thereof.

For plastic recording media, any suitable plastic may be used. Illustrative examples include polyesters such as polyethylene terephthalate and polybutadiene terephthalate; polyolefins such as polyvinyl chloride, polystyrene, polyethylene, polyurethane and polypropylene; and also acrylic resins, polycarbonate, acrylonitrile-butadiene-styrene copolymers, diacetate, triacetate, polyimide, cellophane and celluloid. The thickness and shape of the recording medium when a plastic is used are not subject to any particular limitation. That is, the recording medium may be in the form of a film-like, card-like or block-like shape, and may be either clear or opaque.

It is preferable to use as this plastic recording medium any of various types of film-like, non-absorbing plastics employed in soft packaging, or films made thereof. Illustrative examples of such plastic films include PET films, OPS films, OPP films, PNy films, PVC films, PE films, TAC films and PP films. Other plastics that may be used include polycarbonate, acrylic, ABS, polyacetal and PVA. Use may also be made of rubber.

Illustrative examples of resin-coated paper-type recording media include clear polyester films, opaque polyester films, opaque polyolefin resin films, and paper substrates laminated on both sides with a polyolefin resin. The use of a paper substrate laminated on both sides with a polyolefin resin is especially preferred.

Metal recording media are not subject to any particular limitation. For example, suitable use can be made of aluminum, iron, gold, silver, copper, nickel, titanium, chromium, molybdenum, silicon, lead, zinc and stainless steel, as well as composite materials thereof.

In addition, it is also possible to use as the recording medium read-only optical disks such as CD-ROMs and DVD-ROMs, write-once optical disks such as CD-Rs and DVD-Rs, and rewritable optical disks. In such cases, the image is preferably recorded on the “label” side of the disk.

(Ink and Undercoat liquid)

Inks and undercoat liquids suitable for use in the invention are described in detail below.

The ink, which has at least a composition suitable for forming images, includes at least one polymerizable or crosslinkable material, and optionally includes as well a polymerization initiator, a hydrophilic solvent, a colorant and other ingredients.

The undercoat liquid includes at least one polymerizable or crosslinkable material, and optionally includes as well a polymerization initiator, a hydrophilic solvent, a colorant and other ingredients. It is preferable for the undercoat liquid to be formulated so as to have a different composition than the ink.

The polymerization initiator is preferably a compound which is capable of initiating a polymerization reaction or crosslinking reaction under the influence of active energy rays. An undercoat liquid that has been applied to the coating medium can in this way be cured by exposure to active energy rays.

The undercoat liquid and/or the ink preferably includes a radical-polymerizable composition. As used herein, “radical-polymerizable composition” refers to a composition which includes at least one radical-polymerizable material and at least one radical polymerization initiator. Because the undercoat liquid and/or ink includes a radical-polymerizable composition, the undercoat liquid and/or ink curing reaction can be carried out at a high sensitivity in a short period of time.

Moreover, it is preferable for the ink to include a colorant. It is preferable for the undercoat liquid which is used in combination with this ink to either have a composition that includes no colorant or includes less than 1 wt % of colorant, or to have a composition that includes a white pigment as the colorant.

The various ingredients which make up the ink and/or undercoat liquid are described below.

### (Polymerizable or Crosslinkable Material)

The polymerizable or crosslinkable material has the function of triggering a polymerization or crosslinking reaction with initiating species such as radicals generated from, for example, the subsequently described polymerization initiator, and thus causing the composition containing these to cure.

The polymerizable or crosslinkable material employed may be a polymerizable or crosslinkable material which elicits a known polymerizable or crosslinking reaction such as a radical polymerization reaction and a dimerization reaction. Illustrative examples include addition-polymerizable compounds having at least one ethylenically unsaturated double bond, high-molecular-weight compounds having pendant maleimide groups, and high-molecular-weight compounds having a pendant cinnamyl, cinnamylidene or chalcone group with a photodimerizable unsaturated double bond adjacent to an aromatic ring. Of these, an addition-polymerizable compound having at least one ethylenically unsaturated double bond is preferred. Selection from among compounds having at least one, and preferably two or more, terminal ethylenically unsaturated bonds (monofunctional or polyfunctional compounds) is especially preferred. More specifically, suitable selection may be made from among such compounds that are well-known in the industrial field of the invention, including those having the chemical form of, for example, monomers, prepolymers (i.e., dimers, trimers and oligomers) and mixtures thereof, as well as copolymers thereof.

The polymerizable or crosslinkable materials may be used singly or as a combination of two or more thereof.

The use as the polymerizable or crosslinkable material in the invention of, in particular, any of various known radical-polymerizable monomers in which a polymerization reaction is triggered by an initiating species generated from a radical initiator is preferred.

Examples of radical-polymerizable monomers include (meth)acrylates, (meth)acrylamides, aromatic vinyls, vinyl ethers and compounds having internal double bonds (e.g., maleic acid). Here, “(meth)acrylate” refers to either or both “acrylate” and “methacrylate,” and “(meth)acryl” refers to either or both “acryl” and “methacryl.”

[0154-0155]

Illustrative examples of (meth)acrylates are as follows:

Specific examples of monofunctional (meth)acrylates include hexyl (meth)acrylate, 2-ethylhexyl (meth)acrylate, tert-octyl (meth)acrylate, isoamyl (meth)acrylate, decyl (meth)acrylate, isodecyl (meth)acrylate, stearyl (meth)acrylate, isostearyl (meth)acrylate, cyclohexyl (meth)acrylate, 4-n-butylcyclohexyl (meth)acrylate, bornyl (meth)acrylate, isobornyl (meth)acrylate, benzyl (meth)acrylate, 2-ethyl hexyl diglycol (meth)acrylate, butoxyethyl (meth)acrylate, 2-chloroethyl (meth)acrylate, 4-bromobutyl (meth)acrylate, cyanoethyl (meth)acrylate, benzyl (meth)acrylate, butoxymethyl (meth)acrylate, 3-methoxybutyl (meth)acrylate, alkoxymethyl (meth)acrylate, alkoxyethyl (meth)acrylate, 2-(2-methoxyethoxy)ethyl (meth)acrylate, 2-(2-butoxyethoxy)ethyl (meth)acrylate, 2,2,2-trifluoroethyl (meth)acrylate, 1H,1H,2H,2H-perfluorodecyl (meth)acrylate, 4-butylphenyl (meth)acrylate, phenyl (meth)acrylate, 2,4,5-tetramethylphenyl (meth)acrylate, 4-chiorophenyl (meth)acrylate, phenoxymethyl (meth)acrylate, phenoxyethyl (meth)acrylate, glycidyl (meth)acrylate, glycidyloxybutyl (meth)acrylate, glycidyloxyethyl (meth)acrylate, glycidyloxypropyl (meth)acrylate, tetrahydrofurfuryl (meth)acrylate, hydroxyalkyl (meth)acrylate, 2-hydroxyethyl (meth)acrylate, 3-hydroxypropyl (meth)acrylate, 2-hydroxypropyl (meth)acrylate, 2-hydroxybutyl (meth)acrylate, 4-hydroxybutyl (meth)acrylate, dimethylaminoethyl (meth)acrylate, diethylaminoethyl (meth)acrylate, dimethylaminopropyl (meth)acrylate, diethylaminopropyl (meth)acrylate, trimethoxysilylpropyl (meth)acrylate, trimethylsilylpropyl (meth)acrylate, polyethylene oxide monomethyl ether (meth)acrylate, oligoethylene oxide monomethyl ether (meth)acrylate, polyethylene oxide (meth)acrylate, oligoethylene oxide (meth)acrylate, oligoethylene oxide monoalkyl ether (meth)acrylate, polyethylene oxide monoalkyl ether (meth)acrylate, dipropylene glycol (meth)acrylate, polypropylene oxide monoalkyl ether (meth)acrylate, oligopropylene oxide monoalkyl ether (meth)acrylate, 2-methacryloyloxyethylsuccinic acid, 2-methacryloyloxyhexahydrophthalic acid, 2-methacryloyloxyethyl-2-hydroxypropylphthalate, butoxydiethylene glycol (meth)acrylate, trifluoroethyl (meth)acrylate, perfluorooctylethyl (meth)acrylate, 2-hydroxy-3-phenoxypropyl (meth)acrylate, EO-modified phenol (meth)acrylate, EO-modified cresol (meth)acrylate, EO-modified nonylphenyl (meth)acrylate, PO-modified nonylphenyl (meth)acrylate and EO-modified 2-ethylhexyl (meth)acrylate.

Specific examples of difunctional (meth)acrylates include 1,6-hexanediol di(meth)acrylate, 1,10-decanediol di(meth)acrylate, neopentyl glycol di(meth)acrylate, 2,4-dimethyl-1,5-pentanediol di(meth)acrylate, butylethylpropanediol di(meth)acrylate, ethoxylated cyclohexanemethanol di(meth)acrylate, polyethylene glycol di(meth)acrylate, oligoethylene glycol di(meth)acrylate, ethylene glycol di(meth)acrylate, 2-ethyl-2-butylbutanediol di(meth)acrylate, hydroxypivalic acid neopentyl glycol di(meth)acrylate, EO-modified bisphenol A di(meth)acrylate, bisphenol F polyethoxy di(meth)acrylate, polypropylene glycol di(meth)acrylate, oligopropylene glycol di(meth)acrylate, 1,4-butanediol di(meth)acrylate, 2-ethyl-2-butylpropanediol di(meth)acrylate, 1,9-nonane di(meth)acrylate, propoxylated ethoxylated bisphenol A di(meth)acrylate and tricyclodecane di(meth)acrylate.

Specific examples of trifunctional (meth)acrylates include trimethylolpropane tri(meth)acrylate, trimethylolethane tri(meth)acrylate, the alkylene oxide-modified tri(meth)acrylate of trimethylolpropane, pentaerythritol tri(meth)acrylate, dipentaerythritol tri(meth)acrylate, trimethylolpropane tris((meth)acryloyloxypropyl)ether, isocyanuric acid alkylene oxide-modified tri(meth)acrylate, propionic acid dipentaerythritol tri(meth)acrylate, tris((meth)acryloyloxyethyl)isocyanurate, hydroxypivalaldehyde-modified dimethylolpropane tri(meth)acrylate, sorbitol tri(meth)acrylate, propoxylated trimethylolpropane tri(meth)acrylate and ethoxylated glycerol triacrylate.

Specific examples of tetrafunctional (meth)acrylates include pentaerythritol tetra(meth)acrylate, sorbitol tetra(meth)acrylate, ditrimethylolpropane tetra(meth)acrylate, propionic acid dipentaerythritol tetra(meth)acrylate and ethoxylated pentaerythritol tetra(meth)acrylate.

Specific examples of pentafunctional (meth)acrylates include sorbitol penta(meth)acrylate and dipentaerythritol penta(meth)acrylate.

Specific examples of hexafunctional (meth)acrylates include dipentaerythritol hexa(meth)acrylate, sorbitol hexa(meth)acrylate, the alkylene oxide-modified hexa(meth)acrylate of phosphazene, and captolactone-modified dipentaerythritol hexa(meth)acrylate.

Examples of (meth)acrylamides include (meth)acrylamide, N-methyl (meth)acrylamide, N-ethyl (meth)acrylamide, N-propyl (meth)acrylamide, N-n-butyl (meth)acrylamide, N-t-butyl (meth)acrylamide, N-butoxymethyl (meth)acrylamide, N-isopropyl (meth)acrylamide, N-methylol (meth)acrylamide, N,N-dimethyl (meth)acrylamide, N,N-diethyl (meth)acrylamide and (meth)acryloylmorpholine.

Examples of aromatic vinyls include styrene, methylstyrene, dimethylstyrene, trimethylstyrene, ethylstyrene, isopropylstyrene, chloromethylstyrene, methoxystyrene, acetoxystyrene, chlorostyrene, dichlorostyrene, bromostyrene, methyl vinylbenzoate, 3-methylstyrene, 4-methylstyrene, 3-ethylstyrene, 4-ethylstyrene, 3-propylstyrene, 4-propylstyrene, 3-butylstyrene, 4-butylstyrene, 3-hexylstyrene, 4-hexylstyrene, 3-octylstyrene, 4-octylstyrene, 3-(2-ethylhexyl)styrene, 4-(2-ethylhexyl)styrene, allylstyrene, isopropenylstyrene, butenylstyrene, octenylstyrene, 4-t-butoxycarbonylstyrene, 4-methoxystyrene and 4-t-butoxystyrene.

Vinyl ethers are exemplified by monovinyl ethers such as methyl vinyl ether, ethyl vinyl ether, propyl vinyl ether, n-butyl vinyl ether, t-butyl vinyl ether, 2-ethylhexyl vinyl ether, n-nonyl vinyl ether, lauryl vinyl ether, cyclohexyl vinyl ether, cyclohexyl methyl vinyl ether, 4-methylcyclohexyl methyl vinyl ether, benzyl vinyl ether, dicyclopentenyl vinyl ether, 2-dicyclopentenoxyethyl vinyl ether, methoxyethyl vinyl ether, ethoxyethyl vinyl ether, butoxyethyl vinyl ether, methoxyethoxyethyl vinyl ether, ethoxyethoxyethyl vinyl ether, methoxypolyethylene glycol vinyl ether, tetrahydrofurfuryl vinyl ether, 2-hydroxyethyl vinyl ether, 2-hydroxypropyl vinyl ether, 4-hydroxybutyl vinyl ether, 4-hydroxymethylcyclohexyl methyl vinyl ether, diethylene glycol monovinyl ether, polyethylene glycol vinyl ether, chloroethyl vinyl ether, chlorobutyl vinyl ether, chloroethoxyethyl vinyl ether, phenylethyl vinyl ether and phenoxypolyethylene glycol vinyl ether.

Examples of polyvinyl ethers include divinyl ethers such as ethylene glycol divinyl ether, diethylene glycol divinyl ether, polyethylene glycol divinyl ether, propylene glycol divinyl ether, butylene glycol divinyl ether, hexanediol divinyl ether, bisphenol A alkylene oxide divinyl ether and bisphenol F alkylene oxide divinyl ether; and other polyvinyl ethers such as trimethylolethane trivinyl ether, trimethylolpropane trivinyl ether, ditrimethylolpropane tetravinyl ether, glycerol trivinyl ether, pentaerythritol tetravinyl ether, dipentaerythritol pentavinyl ether, dipentaerythritol hexavinyl ether, ethylene oxide adducts of trimethylolpropane trivinyl ether, propylene oxide adducts of trimethylolpropane trivinyl ether, ethylene oxide adducts of ditrimethylolpropane tetravinyl ether, propylene oxide adducts of ditrimethylolpropane tetravinyl ether, ethylene oxide adducts of pentaerythritol tetravinyl ether, propylene oxide adducts of pentaerythritol tetravinyl ether, ethylene oxide adducts of dipentaerythritol hexavinyl ether and propylene oxide adducts of dipentaerythritol hexavinyl ether.

From the standpoint of such considerations as curability, adhesion to the recording medium and surface hardness of the formed image, it is preferable to use as the vinyl ether compound a di- or trivinyl ether compound. The use of a divinyl ether compound is especially preferred.

In addition to the above, other examples of radical-polymerizable monomers include vinyl esters (e.g., vinyl acetate, vinyl propionate, vinyl versatate), allyl esters (e.g., allyl acetate), halogen-bearing monomers (e.g., vinylidene chloride, vinyl chloride), vinyl cyanides (e.g., (meth)acrylonitrile), and olefins (e.g., ethylene, propylene).

Of the above, from the standpoint of the cure rate, it is preferable to use (meth)acrylates and (meth)acrylamides as the radical-polymerizable monomer. The use of (meth)acrylates having a functionality of 4 or more is especially preferred for achieving a good cure rate. In addition, from the standpoint of the viscosity of the ink composition, the use of a polyfunctional (meth)acrylate in combination with a monofunctional or bifunctional (meth)acrylate or (meth)acrylamide is preferred.

The content of the polymerizable or crosslinkable material in the ink and the undercoat liquid is preferably in a range of 50 to 99.6 wt %, more preferably in a range of 70 to 99.0 wt %, and even more preferably in a range of 80 to 99.0 wt %, based on the weight of the total solids in each droplet.

The content in a droplet, based on the total weight of each droplet, is preferably in a range of 20 to 98 wt %, more preferably in a range of 40 to 95 wt %, and most preferably in a range of 50 to 90 wt %.

### (Polymerization Initiator)

It is preferable for at least the undercoat liquid, or for both the ink and the undercoat liquid, to include at least one polymerization initiator. This initiator is a compound which generates initiating species such as radicals when the energy of active rays, heat or both is applied thereto, thereby initiating and promoting a polymerization or crosslinking reaction of the above-described polymerizable or crosslinkable material so as to effect curing.

The polymerizable material preferably includes a polymerization initiator which triggers radical polymerization. A photopolymerization initiator is especially preferred.

Photopolymerization initiators are compounds which incur a chemical change due to the action of light or to interactions with the electronically excited state of a sensitizing dye, and generates at least one of the following: a radical, an acid or a base. Of such compounds, a photoradical generator is preferred for initiating polymerization by the simple means of exposure to light.

The photopolymerization initiator used in the invention may be suitably selected from among those having sensitivity to the active rays used for exposure, such as 400 nm to 200 nm ultraviolet light, far-ultraviolet light, g-line radiation, h-line radiation, i-line radiation, KrF excimer laser light, ArF excimer laser light, electron beams, x-rays, molecular beams and ion beams.

Any photopolymerization initiator known to those skilled in the art may be used without limitation. Numerous examples are mentioned in, for example, B. M. Monroe et al.: Chemical Revue 93, 435 (1993); R. S. Davidson: Journal of Photochemistry and Biology A: Chemistry 73, 81 (1993); J. P. Faussier: “Photoinitiated Polymerization-Theory and Applications,” in Rapra Review Reports, Vol. 9, Rapra Technology, Ltd. (1998); and M. Tsunooka et al.: Prog. Polym. Sci. 21, 1 (1996). in addition, use may also be made of the group of compounds mentioned in, for example, F. D. Saeva: Topics in Current Chemistry 156, 59 (1990); G. G. Maslak: Topics in Current Chemistry 168, 1 (1993); H. B. Shuster et al.: JACS 112, 6329 (1990); and I. D. F. Eaton et al.: JACS 102, 3298 (1980), which undergo oxidative or reductive bond cleavage through interactions with the electronically excited state of the sensitizing dye.

Preferred photopolymerization initiators include (a) aromatic ketones, (b) aromatic onium salt compounds, (c) organic peroxides, (d) hexaarylbiimidazole compounds, (e) ketoxime ester compounds, (f) borate compounds, (g) azinium compounds, (h) metallocene compounds, (i) active ester compounds, and (j) compounds having carbon-halogen bonds.

Preferred examples of aromatic ketones (a) include the compounds having a benzophenone skeleton or a thioxanthone skeleton mentioned on pages 77 to 117 of Radiation Curing in Polymer Science and Technology by J. P. Fouassier and J. F. Rabek (1993). More preferred examples of aromatic ketones (a) include the α-thiobenzophenone compounds mentioned in JP 47-6416 B, the benzoin ether compounds mentioned in JP 47-3981 B, the α-substituted benzoin compounds mentioned in JP 47-22326 B, the benzoin derivatives mentioned in JP 47-23664 B, the aroylphosphonic acid esters mentioned in JP 57-30704 A, the dialkoxybenzophenones mentioned in JP 60-26483 B, the benzoin ethers mentioned in JP 60-26403 B and 62-81345 A, the α-aminobenzophenones mentioned in JP 1-34242 B, U.S. Pat. No. 4,318,791 and EP 0284561 A, the p-di(dimethylaminobenzoyl) benzenes mentioned in JP 2-211452 A, the thio-substituted aromatic ketones mentioned in JP 61-194062 A, the acylphosphine sulfides mentioned in JP 2-9597 B, the acylphosphines mentioned in JP 2-9596 B, the thioxanthones mentioned in JP 63-61950 B, and the coumarins mentioned in JP 59-42864 B.

Exemplary aromatic onium salt compounds (b) include aromatic onium salts of periodic table group V, VI, and VII elements such as nitrogen, phosphorus, arsenic, antimony, bismuth, oxygen, sulfur, selenium, tellurium and iodine. Preferred examples include iodonium salts mentioned in EP 104143 B, U.S. Pat. No. 4,837,124, JP 2-150848 A and JP 2-96514 A; sulfonium salts mentioned in EP 370693 B, EP 233567 B, EP 297443 B, EP 297442 B, EP 279210 B, EP 422570 B, U.S. Pat. No. 3,902,144, U.S. Pat. No. 4,933,377, U.S. Pat. No. 4,760,013, U.S. Pat. No. 4,734,444 and U.S. Pat. No. 2,833,827; diazonium salts (e.g., benzenediazonium salts which may be substituted), diazonium salt resins (e.g., formaldehyde resins of diazodiphenylamine), N-alkoxypyridinium salts (such as those mentioned in U.S. Pat. No. 4,743,528, JP 63-138345 A, JP 63-142345 A, JP 63-142346 A and JP 46-42363 B, a specific example being 1-methoxy-4-phenylpyridinium tetrafluoroborate), and the compounds mentioned in JP 52-147277 B, JP 52-14278 B and JP 52-14279 B. A radical or an acid is generated as the active species.

Exemplary organic peroxides (c) include substantially all organic compounds having one or more oxygen-oxygen bond in the molecule. For example, it is preferable to use a peroxidized ester such as 3,3′,4,4′-tetrakis(t-butylperoxycarbonyl)benzophenone, 3,3′,4,4′-tetrakis(t-amylperoxycarbonyl)benzophenone, 3,3′,4,4′-tetrakis(t-hexylperoxycarbonyl)benzophenone, 3,3′,4,4′-tetrakis(t-octylperoxycarbonyl)benzophenone, 3,3′,4,4′-tetrakis(cumylperoxycarbonyl)benzophenone, 3,3′,4,4′-tetrakis(p-isopropylcumylperoxycarbonyl)benzophenone and di-t-butyldiperoxyisophthalate.

Exemplary hexaarylbiimidazoles (d) include the lophine dimers mentioned in JP 45-37377B and JP 44-86516 B, such as 2,2′-bis(o-chlorophenyl)-4,4′,5,5′-tetraphenylbiimidazole, 2,2′-bis(o-bromophenyl)-4,4′,5,5′-tetraphenylbiimidazole, 2,2′-bis(o,p-dichlorophenyl)-4,4′,5,5′-tetraphenylbiimidazole, 2,2′-bis(o-chlorophenyl)-4,4′,5,5′-tetrakis(m-methoxyphenyl)biimidazole, 2,2′-bis(o,o′-dichlorophenyl)-4,4′,5,5′-tetraphenylbiimidazole, 2,2′-bis(o-nitrophenyl)-4,4′,5,5′-tetraphenylbiimidazole, 2,2′-bis(o-methylphenyl)-4,4′,5,5′-tetraphenylbiimidazole and 2,2′-bis(o-trifluorophenyl)-4,4′,5,5′-tetraphenylbiimidazole.

Exemplary ketoxime esters (e) include 3-benzoyloxyiminobutan-2-one, 3-acetoxyiminobutan-2-one, 3-propionyloxyiminobutan-2-one, 2-acetoxyiminopentan-3-one, 2-acetoxyimino-1-phenylpropan-1-one, 2-benzoyloxyimino-1-phenylpropan-1-one, 3-p-toluenesulfonyloxyiminobutan-2-one and 2-ethoxycarbonyloxyimino-1-phenylpropane-1-one.

Exemplary borate compounds (f) include the compounds mentioned in U.S. Pat. No. 3,567,453, U.S. Pat. No. 4,343,891, EP 109,772 B and EP 109,773 B.

Exemplary azinium salt compounds (g) include the group of //compounds having N—O bonds mentioned in JP 63-138345 A, JP 63-142345 A, JP 63-142346 A, JP 63-143537 A and JP 46-42363 B.

Exemplary metallocene compounds (h) include the titanocene compounds mentioned in JP 59-152396 A, JP 61-151197 A, JP 63-41484 A, JP 2-249 A, JP 2-4705 A, and the iron-arene complexes mentioned in JP 1-304453 A and JP 1-152109 A.

Specific examples of titanocene compounds include dicyclopentadienyl titanium dichloride, dicyclopentadienyl titanium bisphenyl, dicyclopentadienyl titanium bis-2,3,4,5,6-pentafluorophen-1-yl, dicyclopentadienyl titanium bis-2,3,5,6-tetratluorophen-1-yl, dicyclopentadienyl titanium bis-2,4,6-trifluorophen-1-yl, dicyclopentadienyl titanium 2,6-difluorophen-1-yl, dicyclopentadienyl titanium bis-2,4-difluorophen-1-yl, dimethylcyclopentadienyl titanium bis-2,3,4,5,6-pentafluorophen-1-yl, dimethylcyclopentadienyl titanium bis-2,3,5,6-tetrafluorophen-1-yl, dimethylcyclopentadienyl titanium bis-2,4-difluorophen-1-yl, bis(cyclopentadienyl)-bis(2,6-difluoro-3-(pyr-1-yl)phenyl)titanium, bis(cyclopentadienyl)bis[2,6-difluoro-3-(methylsulfonamide)phenyl]titanium, bis(cyclopentadienyl)bis[2,6-difluoro-3-(N-butylbiaroylamino)phenyl]titanium.

Exemplary active ester compounds (i) include the nitrobenzyl ester compounds mentioned in EP 0290750 B, EP 046083 B, EP 156153 B, EP 271851 B, EP 0388343 B, U.S. Pat. No. 3,901,710, U.S. Pat. No. 4,181,531, JP 60-198538 A and JP 53-133022 A; the iminosulfonate compounds mentioned in EP 0199672 B, EP 84514 B, EP 199672 B, EP 044115 B, EP 0101122 B, U.S. Pat. No. 4,618,564, U.S. Pat. No. 4,371,605, U.S. Pat. No. 4,431,774, JP 64-18143 A, JP 2-245756 A, and JP 4-365048 A; and the compounds mentioned in JP 62-6223 B, JP 63-14340 B and JP 59-174831 A.

Preferred examples of compounds having carbon-halogen bonds (j) include the compounds mentioned by Wakabayashi et al. in Bull. Chem. Soc. Japan 42, 2924 (1969), the compounds mentioned in GB 1388492 B, the compounds mentioned in JP 53-133428 A, and the compounds mentioned in DE 3337024 B.

Additional examples include the compounds mentioned by F. C. Schaefer et al. in J. Org. Chem. 29, 1527 (1964), the compounds mentioned in JP 62-58241 A, the compounds mentioned in JP 5-281728 A, compounds such as those mentioned in DE 2641100 B, the compounds mentioned in DE 3333450 B, the groups of compounds mentioned in DE 3021590 B and the groups of compounds mentioned in DE 3021599 B.

Illustrative, non-limiting examples of the photopolymerization initiator used in the invention include the following compounds.

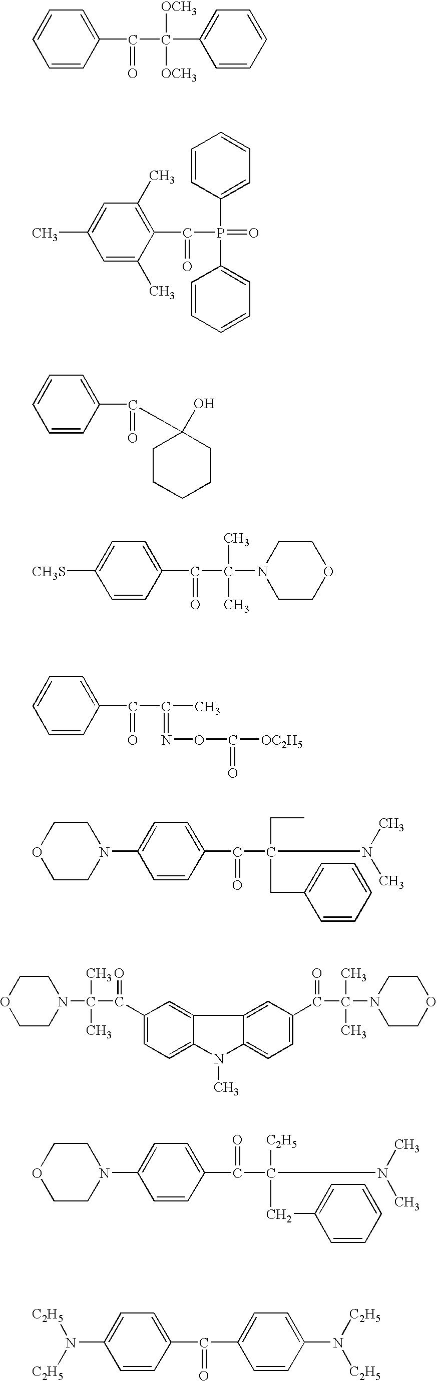

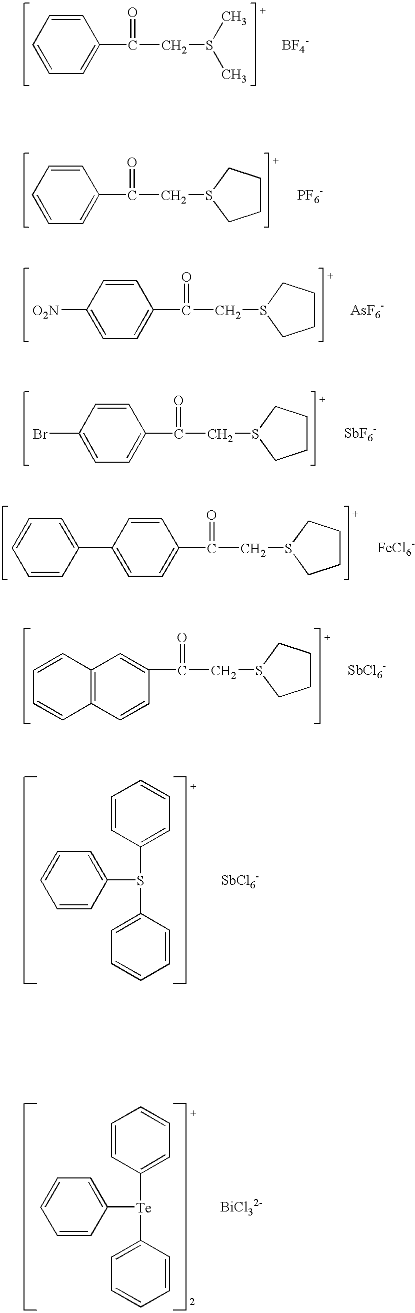

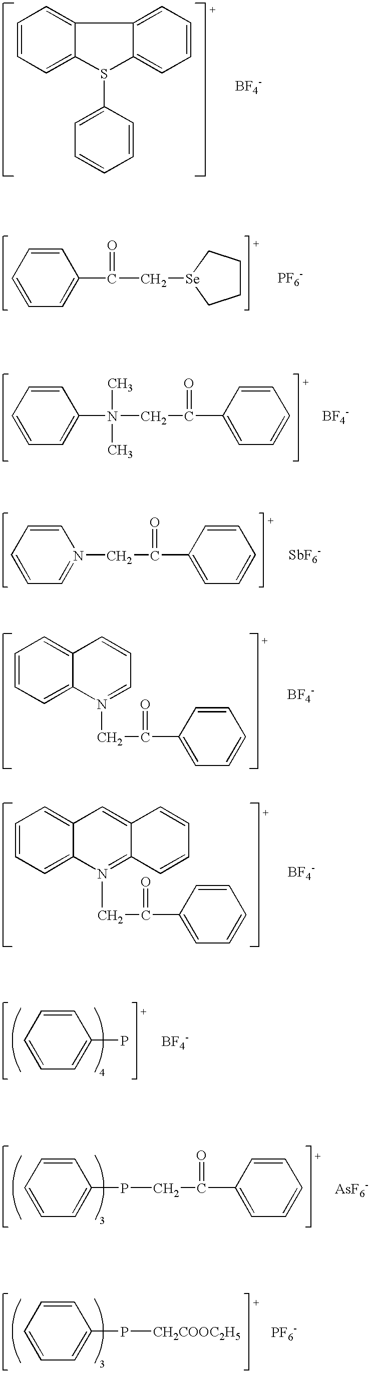

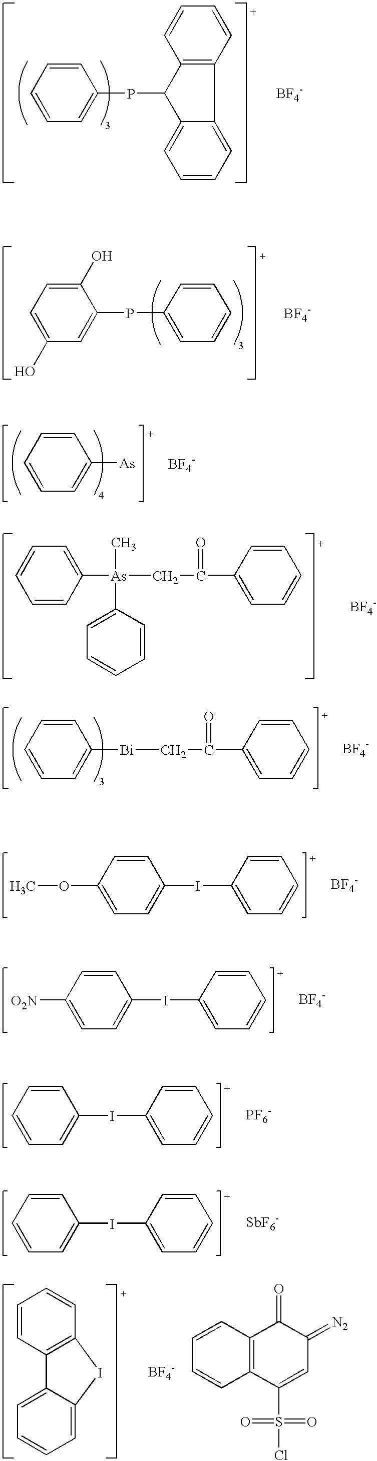

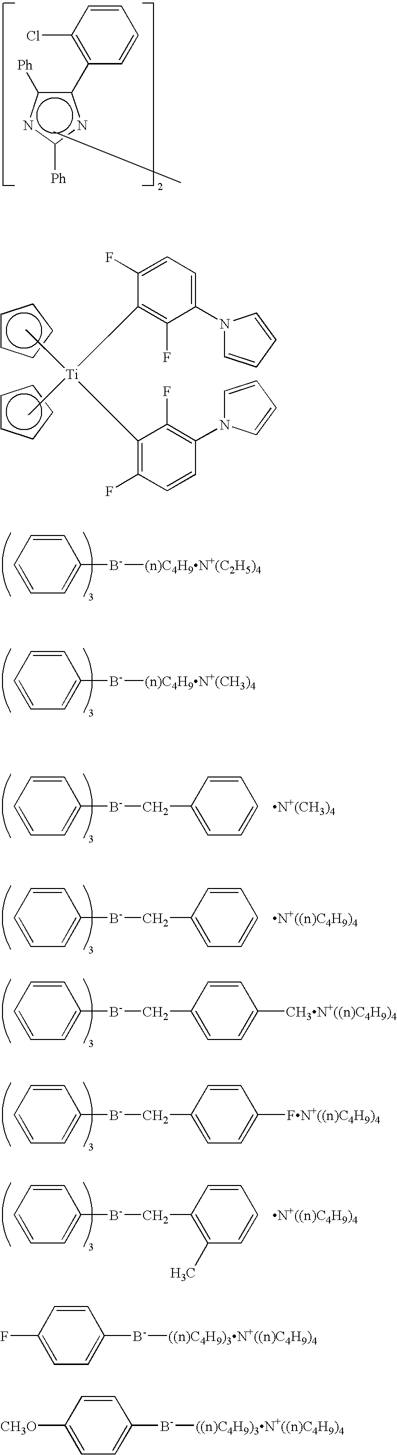

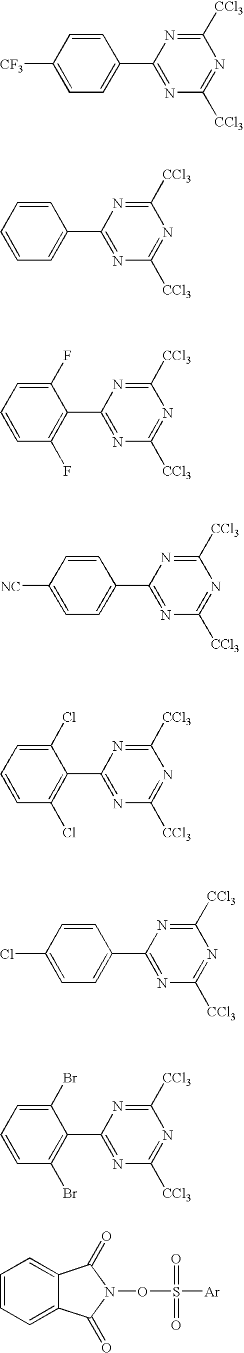

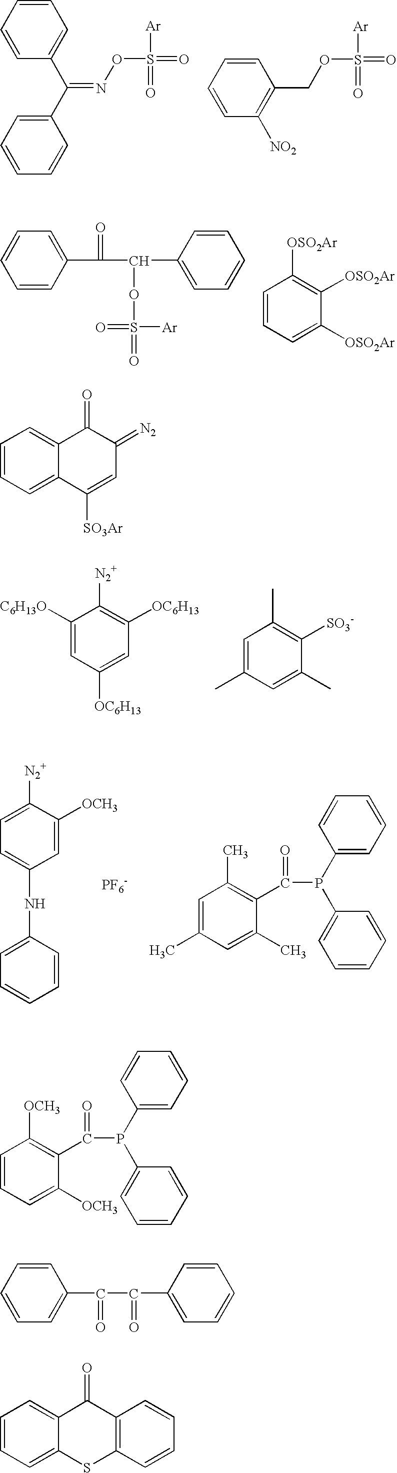

It is desirable for the polymerization initiator to have an excellent sensitivity, although from the standpoint of storage stability, the use of an initiator which does not trigger thermal decomposition at temperatures up to 80° C. is preferred.

The polymerization initiator may be used singly or as a combination of two or more thereof. To enhance the sensitivity, a known sensitizer may be used together with the initiator, insofar as the objects of the invention are attainable.

For a good stability over time, curability and cure rate, the content of the initiator in the undercoat liquid is preferably within a range of 0.5 to 20 wt %, more preferably 1 to 15 wt %, and most preferably 3 to 10 wt %, based on the polymerizable material in the undercoat liquid. By setting the content within the above range, problems such as deposition and separation over time, and deterioration in properties, including the strength and scuff resistance of the ink after curing, can be suppressed.

In addition to being included in the undercoat liquid, the polymerization initiator may also be included in the ink. If such an initiator is included in the ink, the initiator may be suitably selected and included within a range that enables the storage stability of the ink to be maintained at a desired level. In such a case, it is advantageous for the initiator content, based on the polymerizable or crosslinkable compound in the ink, to be set in a range of preferably 0.5 to 20 wt %, and more preferably 1 to 15 wt %.

### (Sensitizing Dye)

It is desirable to add a sensitizing dye to the ink and/or undercoat liquid in order to enhance the sensitivity of the photopolymerization initiator. Preferred sensitizing dyes are exemplified by those compounds among the following which have an absorption wavelength in the range of 350 nm to 450 nm: polycyclic aromatic compounds (e.g., pyrene, perylene, triphenylene), xanthenes (e.g., fluorescein, eosin, erythrosine, rhodamine B, rose bengal), cyanines (e.g., thiacarbocyanine, oxacarbocyanine), merocyanines (e.g., merocyanine, carbomerocyanine), thiazines (e.g., thionine, methylene blue, toluidine blue), acridines (e.g., acridine orange, chloroflavine, acriflavine), anthraquinones (e.g., anthraquinone), squaliums (e.g., squalium) and coumarins (e.g., 7-diethylamino-4-methylcoumarin).

More preferred examples of sensitizing dyes include compounds having the general formulas IX to XIII below.

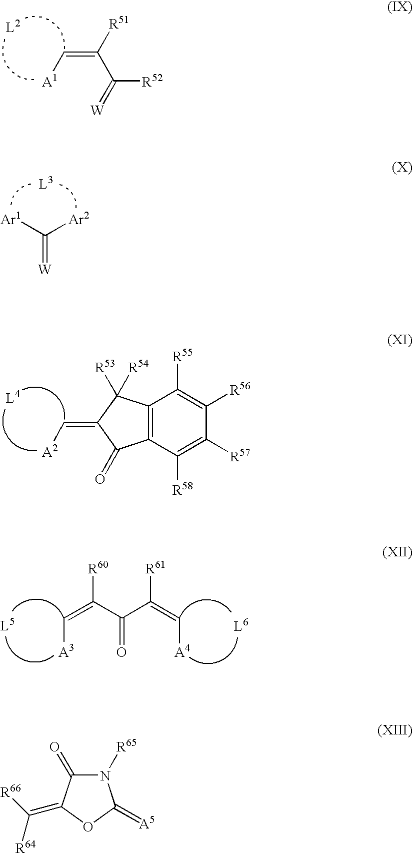

In formula IX, A¹ represents a sulfur atom or —NR⁵⁰—; and R⁵⁰ is an alkyl or aryl group; L² is a non-metallic atomic group which forms, together with the neighboring A¹ and the neighboring carbon atom, the basic nucleus of the dye. R⁵¹ and R⁵² are each independently a hydrogen atom or a monovalent non-metallic atomic group, and may bond together to form the acidic nucleus of the dye. W is an oxygen atom or a sulfur atom.

In formula X, Ar¹ and Ar are each independently an aryl group, and are linked through -L³-. Here, -L³- represents —O— or —S—. W is the same as in general formula IX.

In formula XI, A² represents a sulfur atom or —NR⁵⁹—, and L⁴ is a non-metallic atomic group which forms, together with the neighboring A² and carbon atom, the basic nucleus of the dye. R⁵³, R⁵⁴, R⁵⁵, R⁵⁶, R⁵⁷ and R⁵⁸ are each independently a monovalent non-metallic atomic group, and R⁵⁹ is an alkyl or aryl group.

In formula XII, A³ and A⁴ each independently represent —S—, —NR⁶²— or —NR⁶³—; R⁶² and R⁶³ are each independently a substituted or unsubstituted alkyl group or a substituted or unsubstituted aryl group; L⁵ and L⁶ are each independently a non-metallic atomic group which forms, together with the neighboring A³ and A⁴ and the neighboring carbon atom, the basic nucleus of the dye; and R⁶⁰ and R⁶¹ are each independently a hydrogen atom or a monovalent non-metallic atomic group, or may bond together to form an aliphatic or aromatic ring.

In formula XIII, R⁶⁶ is an aromatic ring or hetero ring which may be substituted; and A⁵ is an oxygen atom, a sulfur atom or —NR⁶⁷—. R⁶⁴, R⁶⁵ and R⁶⁷ are each independently a hydrogen atom or a monovalent non-metallic atomic group, and R⁶⁷ may bond with and R⁶⁵ may bond with R⁶⁷ to form, respectively, an aliphatic or aromatic ring.

Preferred examples of compounds having general formulas IX to XIII include compounds A-1 to A-20 shown below.

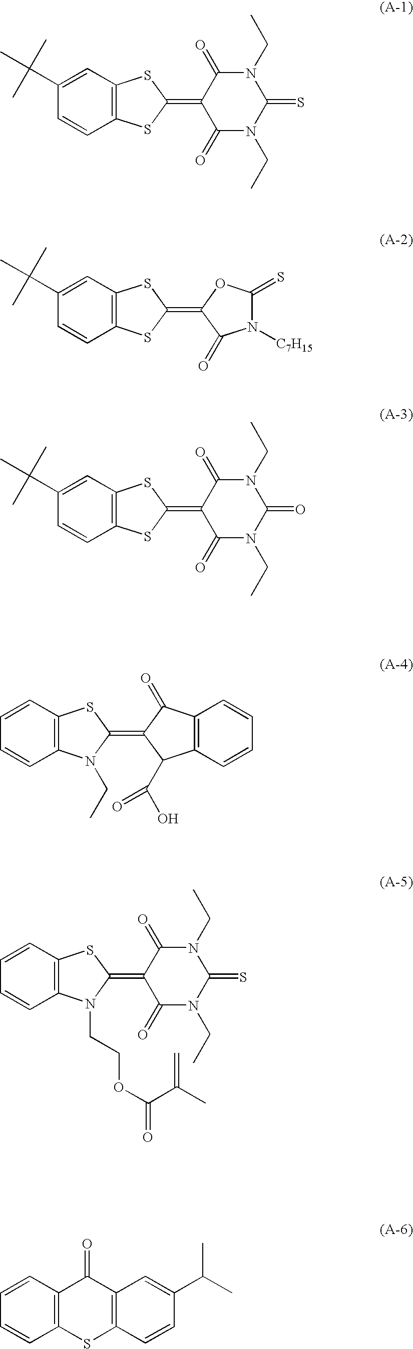

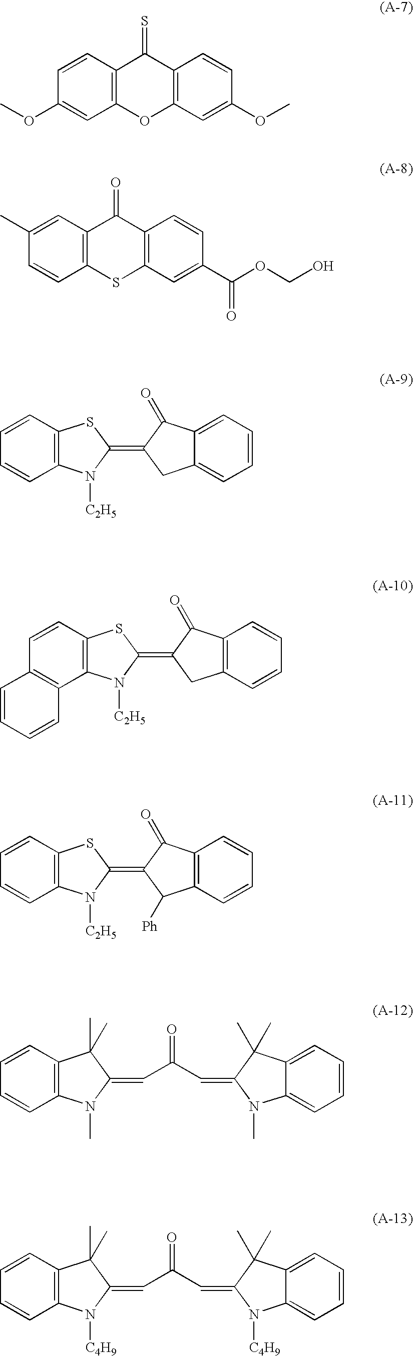

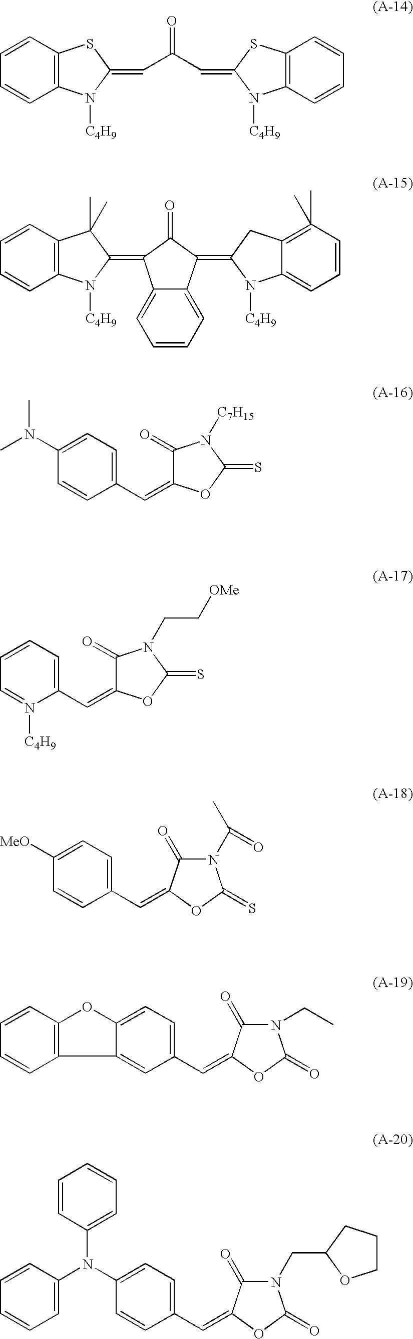

### (Co-Sensitizer)

It is also desirable to add to the ink and/or undercoat liquid, as a co-sensitizer, a known compound which acts to, for example, further enhance the sensitivity or suppress the inhibition of polymerization by oxygen.

Exemplary co-sensitizers include compounds mentioned in, for example, M. R. Sander et al.: Journal of Polymer Society 10, (1972); JP 44-20189 B, JP 51-82102 A, JP 52-134692 A, JP 59-138205 A, JP 60-84305 A, JP 62-18537 A, JP 64-33104 A, and Research Disclosure 33825. Specific examples include triethanolamine, ethyl p-dimethylaminobenzoate, p-formyldimethylaniline and p-methylthiodimethylaniline.

Other exemplary co-sensitizers include the thiol compounds mentioned in JP 53-702 A, JP 55-500806 B and JP 5-142772 A, and the disulfide compounds mentioned in JP 56-75643 A. Specific examples of these include 2-mercaptobenzothiazole, 2-mercaptobenzoxazole, 2-mercaptobenzimidazole, 2-mercapto-4-(3H)-quinazoline and β-mercaptonaphthalene.

Still further examples include amino acid compounds (e.g., N-phenylglycine), the organometallic compounds mentioned in JP 48-42965 B (e.g., tributyltin acetate), hydrogen donors mentioned in JP 55-34414 B, the sulfur compounds mentioned in JP 6-308727 A (e.g., trithiane), the phosphorus compounds mentioned in JP 6-250387 A (e.g., diethylphosphite) and the Si—H and Ge—H compounds mentioned in JP 8-65779 A.

### (Colorants)

At least the ink, or both the ink and the undercoat liquid, include at least one colorant. Colorants may be included not only in the ink, but also in the undercoat liquid and in other liquids.

The colorants used are not subject to any particular limitation, and may be suitably selected from among, for example, known water-soluble dyes, oil-soluble dyes and pigments. Of these, in cases where the ink and the undercoat liquid are composed of water-insoluble organic solvent systems capable of suitably achieving the objects of the invention, it is preferable for the colorant to be an oil-soluble dye or a pigment which can be easily dispersed or dissolved uniformly in the water-insoluble medium.

The colorant content of the ink is preferably from 1 to 30 wt %, more preferably from 1.5 to 25 wt %, and most preferably from 2 to 15 wt %. When a white pigment is included as a colorant in the undercoat liquid, the colorant content in the undercoat liquid is preferably from 2 to 45 wt %, and more preferably from 4 to 35 wt %.

Pigments suitable for use in the invention are described below.

### Pigments:

The use of a pigment as the colorant is preferred.

The pigment used may be either an organic pigment or an inorganic pigment. Preferred black pigments include carbon black pigments. Black pigments and pigments in the three primary colors of cyan, magenta and yellow are generally used. Pigments having other hues, such as red, green, blue, brown and white; metal luster pigments such as those of gold and silver colors; and colorless or light-colored extender pigments may also be used according to the intended purpose.

Organic pigments are not limited as to their hue. Exemplary organic pigments include perylene, perinone, quinacridone, quinacridonequinone, anthraquinone, anthanthrone, benzimidazolone, disazo condensation, disazo, azo, indanthrone, phthalocyanine, triarylcarbonium, dioxazine, aminoanthraquinone, diketopyrrolopyrrole, thioindigo, isoindoline, isoindolinone, pyranthrone, isoviolanthrone pigments and mixtures thereof.

[0213-0214]

Specific examples include perylene pigments such as C.I. Pigment Red 190 (C.I. No. 71140), C.I. Pigment Red 224 (C.I. No. 71127) and C.I. Pigment Violet 29 (C.I. No. 71129); perinone pigments such as C.I. Pigment Orange 43 (C.I. No. 71105) and C.I. Pigment Red 194 (C.I. No. 71100); quinacridone pigments such as C.I. Pigment Violet 19 (C.I. No. 73900), C.I. Pigment Violet 42, C.I. Pigment Red 122 (C.I. No. 73915), C.I. Pigment Red 192, C.I. Pigment Red 202 (C.I. No. 73907), C.I. Pigment Red 207 (C.I. No. 73900, 73906) and C.I. Pigment Red 209 (C.I. No. 73905); quinacridonequinone pigments such as C.I. Pigment Red 206 (C.I. No. 73900/73920), C.I. Pigment Orange 48 (C.I. No. 73900/73920) and C.I. Pigment Orange 49 (C.I. No. 73900/73920); anthraquinone pigments such as C.I. Pigment Yellow 147 (C.I. No. 60645); anthanthrone pigments such as C.I. Pigment Red 168 (C.I. No. 59300); benzimidazolone pigments such as C.I. Pigment Brown 25 (C.I. No. 12510), C.I. Pigment Violet 32 (C.I. No. 12517), C.I. Pigment Yellow 180 (C.I. No. 21290), C.I. Pigment Yellow 181 (C.I. No. 11777), C.I. Pigment Orange 62 (C.I. No. 11775) and C.I. Pigment Red 185 (C.I. No. 12516); disazo condensation pigments such as C.I. Pigment Yellow 93 (C.I. No. 20710), C.I. Pigment Yellow 94 (C.I. No. 20038), C.I. Pigment Yellow 95 (C.I. No. 20034), C.I. Pigment Yellow 128 (C.I. No. 20037), C.I. Pigment Yellow 166 (C.I. No. 20035), C.I. Pigment Orange 34 (C.I. No. 21115), C.I. Pigment Orange 13 (C.I. No. 21110), C.I. Pigment Orange 31 (C.I. No. 20050), C.I. Pigment Red 144 (C.I. No. 20735), C.I. Pigment Red 166 (C.I. No. 20730), C.I. Pigment Red 220 (C.I. No. 20055), C.I. Pigment Red 221 (C.I. No. 20065), C.I. Pigment Red 242 (C.I. No. 20067), C.I. Pigment Red 248, C.I. Pigment Red 262 and C.I. Pigment Brown 23 (C.I. No. 20060); disazo pigments such as C.I. Pigment Yellow 13 (C.I. No. 21100), C.I. Pigment Yellow 83 (C.I. No. 21108) and C.I. Pigment Yellow 188 (C.I. No. 21094); azo pigments such as C.I. Pigment Red 187 (C.I. No. 12486), C.I. Pigment Red 170 (C.I. No. 12475), C.I. Pigment Yellow 74 (C.I. No. 11714), C.I. Pigment Yellow 150 (C.I. No. 48545), C.I. Pigment Red 48 (C.I. No. 15865)r C.I. Pigment Red 53 (C.I. No. 15585), C.I. Pigment Orange 64 (C.I. No. 12760) and C.I. Pigment Red 247 (C.I. No. 15915); indanthrone pigments such as C.I. Pigment Blue 60 (C.I. No. 69800); phthalocyanine pigments such as C.I. Pigment Green 7 (C.I. No. 74260), C.I. Pigment Green 36 (C.I. No. 74265), C.I. Pigment Green 37 (C.I. No. 74255), C.I. Pigment Blue 16 (C.I. No. 74100), C.I. Pigment Blue 75 (C.I. No. 74160:2) and 15 (C.I. No. 74160); triarylcarbonium pigments such as C.I. Pigment Blue 56 (C.I. No. 42800) and C.I. Pigment Blue 61 (C.I. No. 42765:1); dioxazine pigments such as C.I. Pigment Violet 23 (C.I. No. 51319) and C.I. Pigment Violet 37 (C.I. No. 51345); aminoanthraquinone pigments such as C.I. Pigment Red 177 (C.I. No. 65300); diketopyrrolopyrrole pigments such as C.I. Pigment Red 254 (C.I. No. 56110), C.I. Pigment Red 255 (C.I. No. 561050), C.I. Pigment Red 264, C.I. Pigment Red 272 (C.I. No. 561150), C.I. Pigment Orange 71 and C.I. Pigment Orange 73; thioindigo pigments such as C.I. Pigment Red 88 (C.I. No. 73312); isoindoline pigments such as C.I. Pigment Yellow 139 (C.I. No. 56298) and C.I. Pigment Orange 66 (C.I. No. 48210); isoindolinone pigments such as C.I. Pigment Yellow 109 (C.I. No. 56284) and C.I. Pigment Orange 61 (C.I. No. 11295); pyranthrone pigments such as C.I. Pigment Orange 40 (C.I. No. 59700) and C.I. Pigment Red 216 (C.I. No. 59710); and isoviolanthrone pigments such as C.I. Pigment Violet 31 (C.I. No. 60010).

A combination of two or more organic pigments or organic pigment solid solutions may be used for the colorant.

In addition, any of the following may be used: particles composed of a core of e.g., silica, alumina or resin on the surface of which is fixed a dye or pigment, dyes that have been rendered into insoluble lakes, colored emulsions, and colored latexes. Resin-coated pigments may also be used. These are called microencapsulated pigments, and are commercially available from, for example, Dainippon Ink & Chemicals, Inc. and Toyo Ink Manufacturing Co., Ltd.

For a good balance of optical density and storage stability, the volume-average particle size of the pigment particles included in the liquid is preferably in a range of from 10 to 250 nm, and more preferably from 50 to 200 nm. Here, the volume-average particle size of the pigment particles may be measured by a particle size distribution analyzer such as the LB-500 manufactured by Horiba, Ltd.

A single colorant may be used alone or two or more colorants may be used in admixture. Differing colorants may be used for the respective droplets and liquids that are deposited, or the same colorant may be used.

### (Other Components)

Known additives and ingredients other than those described above may also be used in the ink and/or undercoat liquid in accordance with the intended purpose.

### Storage Stabilizer:

It is preferable to add a storage stabilizer to the ink and undercoat liquid (especially the ink) in order to inhibit undesirable polymerization during storage. It is desirable for the storage stabilizer to be used in the presence of a polymerizable or crosslinkable material. Also, it is advantageous for the storage stabilizer to be soluble in the droplet or liquid which includes it or in another ingredient present therein.

Exemplary storage stabilizers include quaternary ammonium salts, hydroxylamines, cyclic amides, nitrites, substituted ureas, heterocyclic compounds, organic acids, hydroquinone, hydroquinone monoethers, organic phosphines and copper compounds. Specific examples include benzyltrimethylammonium chloride, diethylhydroxylamine, benzothiazole, 4-amino-2,2,6,6-tetramethylpiperidine, citric acid, hydroquinone monomethyl ether, hydroquinone monobutyl ether and copper naphthenate.

It is preferable to suitably adjust the amount of storage stabilizer added based on the activity and polymerizability of the polymerization initiator or the polymerizability of the crosslinkable material, and on the type of storage stabilizer. However, for a good balance of storage stability and curability, it is advantageous to set the solids equivalent of the storage stabilizer in the liquid to from 0.005 to 1 wt %, more preferably from 0.01 to 0.5 wt %, and even more preferably from 0.0l to 0.2 wt %.

### Conductive Salts:

Conductive salts are solid compounds which enhance the electrical conductivity. In the practice of the invention, owing to the concern that deposition may occur during storage, it is preferable for substantially no conductive salt to be used. However, in cases where the solubility is good because the solubility of the conductive salt has been increased or a conductive salt having a high solubility in the liquid component is used, a suitable amount of conductive salt may be added.

Exemplary conductive salts include potassium thiocyanate, lithium nitrate, ammonium thiocyanate and dimethylamine hydrochloride.

### Solvents:

In the invention, a known solvent may be used if necessary. The solvent may be used for such purposes as to improve the polarity, viscosity and surface tension of the liquid (ink), to improve the solubility or dispersibility of the colored material, to adjust the electrical conductivity, and to adjust the printability.

For quick-drying properties and to record high-quality images having uniform line widths, it is preferable that the solvent be a water-insoluble liquid which contains no aqueous medium. Hence, a composition which uses a high-boiling organic solvent is desirable.

It is preferable for the high-boiling organic solvent to have an excellent compatibility with the components of the liquid, especially the monomer.

Specific examples of preferred solvents include tripropylene glycol monomethyl ether, dipropylene glycol monomethyl ether, propylene glycol monomethyl ether, ethylene glycol monobutyl ether, diethylene glycol monobutyl ether, triethylene glycol monobutyl ether, ethylene glycol monobenzyl ether and diethylene glycol monobenzyl ether.

Known solvents also include low-boiling organic solvents with boiling points of up to 100° C. However, owing to concerns over the adverse effects of solvents on curability and taking into account also environmental contamination by low-boiling organic solvents, it is desirable not to use such solvents. If a low-boiling organic solvent is used, the solvent is preferably a highly safe solvent. A “highly safe solvent” refers herein to a solvent having a high control level (the “control level” is an indicator used in the Working Environment Evaluation Standards issued by the Japanese Ministry of Health, Labor and Welfare) of preferably at least 100 ppm, and more preferably at least 200 ppm. Exemplary solvents of this type are alcohols, ketones, esters, ethers and hydrocarbons. Specific examples include methanol, 2-butanol, acetone, methyl ethyl ketone, ethyl acetate and tetrahydrofuran.

The solvent may be used singly or as combinations of two or more. When water and/or a low-boiling organic solvent are used, the amount in which both are used is preferably from 0 to 20 wt %, and more preferably from 0 to 10 wt %, based on each liquid (ink or undercoat liquid). The substantial absence of such solvents is especially preferred. The substantial absence of water in the ink and undercoat liquid used in the invention improves stability over time with respect to clouding of the liquid caused by, for example, a loss of homogeneity and dye deposition over time, and is also able to increase dryability when used on an impermeable or a slowly permeable recording medium. Here, “substantial absence” signifies that the presence of such solvent as an inadvertent impurity is allowable. Other Additives:

Use can also be made of known additives such as polymers, surface tension adjusters, ultraviolet light absorbers, antioxidants, discoloration inhibitors and pH adjusters.

Known compounds may be suitably selected and used as the surface tension adjusters, ultraviolet light absorbers, antioxidants, discoloration inhibitors and pH adjusters. For example, use may be made of the additives mentioned in JP 2001-181549 A.

In addition to the above, a pair of compounds which, when mixed, react to form an agglomerate or thicken may be separately included in the ink and undercoat liquid according to the invention. This pair of compounds has the characteristic of either rapidly forming an agglomerate or rapidly thickening the liquid, thereby more effectively inhibiting the coalescence of mutually neighboring droplets.

Examples of reactions between the pair of compounds include acid-base reactions, hydrogen bonding reactions between a carboxylic acid and an amide group-bearing compound, crosslinking reactions such as between boronic acid and a dial, and reactions involving electrostatic interactions between cations and anions.

Although embodiments of the coater and ink-jet recording device of the present invention have been described for illustrative purposes, those skilled in the art will appreciate that various modifications and improvements are possible without departing from the scope and spirit of the invention as disclosed in the accompanying claims.

As described above, it is preferable to semi-cure the undercoating liquid to form a higher-resolution image on the recording medium, but this is not the sole case of the present invention. For example, an image may be formed by ejecting ink droplets onto the recording medium (more precisely onto the undercoat) after complete curing of the undercoating liquid coated onto the recording medium. Alternatively, an image may also be formed by ejecting ink droplets onto the recording medium (more precisely onto the undercoat) before curing the undercoating liquid coated thereonto. In the latter case, the image areas and the undercoat on the recording medium are simultaneously cured by subsequent irradiation with active rays.

The method of semi-curing the undercoating liquid (undercoat) and/or ink is also not limited to the above-described method. Other methods that may be used for this purpose include known thickening methods, such as methods that use an agglomerating effect, such as by furnishing a basic compound to an acidic polymer or by furnishing an acidic compound and a metal compound to a basic polymer; methods wherein the undercoating liquid (ink) is prepared beforehand to a high viscosity, then the viscosity is lowered by adding thereto a low-boiling organic solvent, after which the low-boiling organic solvent is evaporated so as to return the liquid to its original high viscosity; methods in which the undercoating liquid (ink) prepared at a high viscosity is first heated, then is cooled so as to return the liquid to its original high viscosity; and methods in which the undercoating liquid (ink) is semi-cured through a curing reaction induced by applying heat to the undercoating liquid (ink).

Of these, methods in which the undercoating liquid and ink are semi-cured through a curing reaction induced by the application of heat or by irradiation with the above-described active energy rays are preferred.

In the present embodiment, an active ray-curable undercoating liquid and active ray-curable inks were used as the undercoating liquid and inks, and curing was effected by irradiating the undercoating liquid and inks with active rays. However, the invention is not limited in this regard. That is, use may be made of undercoating liquids and inks other than those which are active light-curable. For example, images may be formed by means already known in the art using heat-curable inks. Likewise, a heat-curable liquid may be used as the undercoating liquid.

In the embodiments described above, the undercoating liquid was semi-cured to enable a higher-resolution and higher-quality image to be formed, but this is not the sole case of the present invention. For example, an image may be formed by an ink-jet system on the undercoat which is not semi-cured (i.e., the undercoat which is in an uncured or cured state). The thus formed image is lower in resolution and quality than the case where the undercoating liquid was semi-cured, but a high-quality and high-resolution print can still be formed because the highly viscous undercoating liquid can be uniformly formed at a high speed.

In the above-mentioned embodiments, the coater has been described as the undercoat forming section for use in coating the undercoating liquid. However, the present invention is not limited to this case. The coater may be used in various coating devices for coating an object with a functional liquid to a certain thickness. For example, the coater of the present invention may be used in coating devices which coat a recording medium with a functional liquid such as an agent for improving image resolution or adhesion upon recording of an image thereon by an ink-jet recording system, and coating devices which coat a print obtained with a vanish in the subsequent treatment.

The ink-jet recording device of the present invention may be used in label printers for printing labels.

What is claimed is:

1. A coater comprising:
a liquid holding vessel which holds a functional liquid;
a coating roll having a surface, a part of which is immersed in said functional liquid in said liquid holding vessel, said coating roll including recesses for retaining said functional liquid;
coating roll rotating means which rotates said coating roll;
liquid flow generating means which flows a region of said functional liquid held in said liquid holding vessel where said functional liquid contacts said coating roll, in a direction opposite to a rotational direction of a portion of said coating roll which is immersed in said functional liquid within said liquid holding vessel; and
transport means which transports an object coated with said functional liquid upon contact with said coating roll.

2. The coater according to claim 1, further comprising vibration means for vibrating one of said coating roll and said functional liquid or both.

3. The coater according to claim 2, wherein said vibration means is disposed at said liquid holding vessel and applies ultrasonic waves to said functional liquid held in said liquid holding vessel.

4. A coater comprising:
a liquid holding vessel which holds a functional liquid;
a coating roll having a surface, a part of which is immersed in said functional liquid in said liquid holding vessel, said coating roll including recesses for retaining said functional liquid;
coating roll rotating means which rotates said coating roll;
a brush which is disposed in a region of said liquid holding vessel where said functional liquid is held so as to be in contact with said coating roll; and
transport means which transports an object coated with said functional liquid upon contact with said coating roll.

5. The coater according to claim 4, further comprising a brush rotating portion for rotating said brush in a direction identical to a rotational direction of said coating roll.

6. The coater according to claim 4, wherein said coating roll rotating means rotates said coating roll in a direction opposite to a direction in which said transport means transports said object.

7. An ink-jet recording device comprising:
a coater; and image forming means,
wherein said coater comprises:
a liquid holding vessel which holds a functional liquid;
a coating roll having a surface, a part of which is immersed in said functional liquid in said liquid holding vessel, said coating roll including recesses for retaining said functional liquid;
coating roil rotating means which rotates said coating roll;
liquid flow generating means which flows a region of said functional liquid held in said liquid holding vessel where said functional liquid contacts said coating roll, in a direction opposite to a rotational direction of a portion of said coating roll which is immersed in said functional liquid within said liquid holding vessel; and
transport means which transports an object coated with said functional liquid upon contact with said coating roll,
wherein a recording medium is used as said object to be coated, and an undercoating liquid is used as said functional liquid, and
wherein said image forming means has at least one ink-jet head which is disposed downstream of said coater in a direction of travel of a recording medium used as said object and where ink containing at least a colorant is ejected onto said recording medium having been coated with an undercoating liquid used as said functional liquid to form an image on said recording medium.

8. The ink-jet recording device according to claim 7, further comprising undercoating liquid semi-curing means which is disposed downstream of said coater in the direction of travel of said recording medium and which irradiates said undercoating liquid coated onto said recording medium with active energy rays to semi-cure said undercoating liquid on said recording medium, said undercoating liquid being a liquid which cures upon application of the active energy rays to said recording medium.

9. The ink-jet recording device according to claim 7,
wherein the ink ejected from said at least one ink-jet head is an ink which cures upon exposure to the active energy rays, and
wherein said image forming means further comprises image curing means which is disposed downstream of said at least one ink-jet head in the direction of travel of the recording medium and which cures the ink making up the image by irradiating the image formed on said recording medium with the active energy rays.

10. The ink-jet recording device according to claim 9,
wherein said at least one ink-jet head in said image forming means comprises two or more ink-jet heads from which inks of different colors are ejected, and
wherein said image forming means further includes ink semi-curing means which is disposed between said two or more ink-jet heads and semi-cures any of the inks making up an image formed by any of said two or more ink-jet heads disposed upstream of said ink semi-curing means in the direction of travel of the recording medium.

11. The coater according to claim 1, wherein said coating roll rotating means rotates said coating roll in a direction opposite to a direction in which said transport means transports said object.

12. An ink-jet recording device comprising:
a coater; and image forming means,
wherein said coater comprises:
a liquid holding vessel which holds a functional liquid;
a coating roll having a surface, a part of which is immersed in said functional liquid in said liquid holding vessel, said coating roll including recesses for retaining said functional liquid;
coating roll rotating means which rotates said coating roll;
a brush which is disposed in a region of said liquid holding vessel where said functional liquid is held so as to be in contact with said coating roll; and
transport means which transports an object coated with said functional liquid upon contact with said coating roll,
wherein a recording medium is used as said object to be coated, and an undercoating liquid is used as said functional liquid, and
wherein said image forming means has at least one ink-jet head which is disposed downstream of said coater in a direction of travel of said recording medium used as said object and where ink containing at least a colorant is ejected onto said recording medium having been coated with an undercoating liquid used as said functional liquid to form an image on said recording medium.

13. The ink-jet recording device according to claim 12, further comprising undercoating liquid semi-curing means which is disposed downstream of said coater in the direction of travel of said recording medium and which irradiates said undercoating liquid coated onto said recording medium with active energy rays to semi-cure said undercoating liquid on said recording medium, said undercoating liquid being a liquid which cures upon application of the active energy rays to said recording medium.

14. The ink-jet recording device according to claim 12,
wherein the ink ejected from said at least one ink-jet head is an ink which cures upon exposure to the active energy rays, and
wherein said image forming means further comprises image curing means which is disposed downstream of said at least one ink-jet head in the direction of travel of the recording medium and which cures the ink making up the image by irradiating the image formed on said recording medium with the active energy rays.

15. The ink-jet recording device according to claim 14,
wherein said at least one ink-jet head in said image forming means comprises two or more ink-jet heads from which inks of different colors are ejected, and
wherein said image forming means further includes ink semi-curing means which is disposed between said two or more ink-jet heads and semi-cures any of the inks making up an image formed by any of said two or more ink-jet heads disposed upstream of said ink semi-curing means in the direction of travel of the recording medium.
